(19) United States
(12) Patent Application Publication
(10) Pub. No.: US 2023/0177191 A1
(43) Pub. Date: Jun. 8, 2023

(54) Methods and Systems for Accessing Information Stored in an Online Vault

(71) Applicant: Clocr, Inc, Austin, TX (US)

(72) Inventor: Apoorva Chintala, Austin, TX (US)

(21) Appl. No.: 17/542,649

(22) Filed: Dec. 6, 2021

(51) Int. Cl. G06F 21/62; H04L 9/32; G06F 21/32; G06F 21/60

(52) U.S. Cl. CPC G06F 21/6218; H04L 9/3239; G06F 21/32; G06F 21/602; H04L 2209/38

(57) ABSTRACT

Methods and systems for creating online vaults to secure digital information are disclosed. The methods and system safeguard digital information and release the information to designated recipients under limited circumstances upon the occurrence of triggers designated by the owner of the digital information.

### TECHNICAL FIELD

The disclosure relates generally to digital asset management and, more particularly, to methods and systems for creating online vaults to secure digital information and developing protocols to carry out the release of the digital information in accordance with the instructions of the digital vault owner. For example, emergency information may be stored in a digital vault with instructions for temporary and limited access to that digital information by preselected individuals, such as emergency personnel or family in the event of an emergency, e.g., a car accident. Likewise, a manuscript may be stored in a digital vault and be authenticated and/or released upon instruction from the digital vault owner.

### BACKGROUND

In the past, people generally stored their valuable information and papers in secure locations such as safety deposit boxes or safes that provided physical security for their belongings. As the world moves from paper transactions to digital transactions, handling, storage, security, and access to valuable digital information has changed. While people are learning to protect their digital assets through cybersecurity, there continue to be large swaths of information that remain unprotected.

In addition, with the enhanced communication that is now available over the internet, people should be able to make select digital information available when it is needed either by them or by a third party, for example, in the event of an emergency. A need exists for cost effective and user-friendly systems where a user can securely store their digital information and have that information released to the appropriate parties when it is needed. The digital vaults as described herein provide people with an improved system for storing their information and an improved method for providing or denying access to their information.

The COVID-19 pandemic has created a number of disruptions to people's lives that they never anticipated and has highlighted problems associated with the management of digital information. The pandemic definitely accelerated every individual's need to be prepared for untimely hospitalization and the death of loved ones. In case of hospitalization, timely access to emergency information like health records and medical insurance details can go a long way. Likewise, during untimely hospitalizations that linger, someone else may have to take care of the day-to-day aspects of another's life and information regarding pets/bills/and other household items would be exceedingly helpful. In the case of death, access to, and knowledge of information like financial details, heirs and legacy planning details can save loved ones a lot of legal hassles and paperwork.

Many people never share the basic information about their lives with even their closest family members. People are generally reluctant to share information for fear of revealing the intimate details of their lives including medical and/or financial affairs. Other information may seem trivial, but when something happens to a person, temporarily or permanently, their family usually has the difficult task of trying to manage their day-to-day affairs. Even if the person has a will, trust, or powers of attorney their loved ones often do not know where they are or how to use them; they do not know how the bills are paid, the person's doctor's name, the name of the school their child attends, or friends the family can count on, and so on. Most people have never managed, much less settled, someone else's day to day affairs and are unaware of the roles and responsibilities they need to take on.

Despite the fact that much of our day to day lives are controlled digitally, most people never think about storing their important information in a manner that makes it easy for the information to be accessed in the event of an emergency or life event.

When someone suffers an inevitable situation requiring exigent information, be it a car accident, medical emergency, arrest, disappearance, fire, or community events, such as a tornado or flood, users have a hard time accessing their own information and/or providing it to an appropriate third parties who can assist the user or resolve the emergent issues.

While certain mobile electronic devices, such as smart phones, can include certain emergency information, such as the identity, contacts, medical conditions, and allergies of the user, they are largely limited to a short list of information. Because of this, they are of limited utility in many exigent situations. Moreover, the use of electronic devices to provide this important information can be problematic in those instances where the device is damaged, or out of power.

In addition, the information a third party may need to access in exigent situations may be of a nature and type that the user generally doesn't make available publicly. Moreover, the quantity of information needed during such circumstances is often greater than the limited information on the emergency screen of an electronic device.

In light of the above discussion, a need exists for a comprehensive online program that allows a user to store and manage not only their important digital information, but also their day-to-day digital information in a manner that allows selective information to be distributed to their designees upon the occurrence of life events that they define. Such an application allows people to organize, maintain and share digital information so that if anything should happen to them their designees can more easily obtain and distribute any information needed to resolve whatever emergent issue the user encounters.

Moreover, a need also exists for a means of initiating controlled access to selective digital information of a user in a variety of situations and locations.

### SUMMARY

A digital vault, as described herein, makes it possible for someone to store and manage their important personal information and release limited amounts of that information to the right parties for limited times without comprising the confidentiality of any other information.

Various embodiments of the present disclosure provide methods and systems for establishing one or more digital vaults which contain user information which at the appropriate time is shared with designated recipients for a limited time.

In an embodiment, a method is disclosed. The method includes providing limited, controlled access to digital information of a user by (a) creating, by a processor, a digital vault of a user, the digital vault comprising storing, by the processor, encrypted digital information of the user in one or more predetermined destination locations; (b) permitting, by the processor, the user to allocate encrypted digital information in the digital vault into one or more digital sub-vaults; (c) permitting, by the processor, the user to allocate one or more sub-vault access contacts with controlled access to one or more sub-vaults; (d) permitting, by the processor, the user to allocate digital sub-vault access to the allocated digital sub-vault access contact of step (c) based on the occurrence of one or more vault access circumstances; (e) receiving, by the processor, notification that a sub-vault access circumstance has occurred; and (f) providing, by the processor, the sub-vault access contact(s), with controlled access to a sub-vault upon the occurrence of the sub-vault access circumstances of step (d), the controlled access includes (i) verifying the identity of a sub-vault access contact and (ii) allowing access for a limited period of time.

In another embodiment, a method is disclosed. The method comprises providing limited, controlled access to digital information of a user by (a) creating, by a processor, a digital vault of a user, comprising storing, by the processor, encrypted digital information of the user in one or more predetermined destination locations; (b) permitting, by the processor, the user to allocate one or more digital vault access contacts; (c) permitting, by the processor, the user to allocate digital vault access to the allocated digital vault access contact of step (b) based on the occurrence of one or more vault access circumstances; (d) receiving, by the processor, notification that a vault access circumstance of step (c) has occurred; and (e) providing, by the processor, the allocated contact(s), with controlled access to digital information in the digital vault consistent with the allocations of step (c), the controlled access includes (i) verifying the identity of a digital vault access contact and (ii) allowing access for a limited period of time.

In yet another embodiment, a computer readable medium is disclosed. The non-transitory computer readable storage medium is configured to store instructions that, when executed by at least one processor included in a computing device, cause the computing device to perform a method for providing controlled access to digital information of a user comprising, (a) creating a digital vault comprising storing encrypted digital information of a user in one or more predetermined destination locations; (b) creating one or more digital sub-vaults comprising permitting the user to allocate the encrypted digital information in the digital vault into one or more digital sub-vaults; (c) permitting the user to allocate one or more sub-vault access contacts with controlled access to one or more digital sub-vaults; (d) permitting the user to allocate sub-vault access to one or more sub-vault access contacts based on the occurrence of one or more sub-vault access circumstances; (e) providing the sub-vault access contact(s), with controlled access to a sub-vault consistent with the allocations of step (d), the controlled access includes (i) validating the identity of a sub-vault access contact and (ii) allowing access for a limited period of time.

In yet another embodiment, a computer readable medium is disclosed. The computer readable medium provides designated recipients with limited, controlled access to digital information of a user. The medium is configured to store instructions that, when executed by at least one processor included in a computing device, cause the computing device to perform a method including (a) creating a digital vault, the digital vault comprising stored encrypted digital information of the user in one or more predetermined destination locations; (b) permitting the user to allocate access to the digital vault to one or more digital vault access contacts; (c) permitting the user to allocate digital vault access to the digital vault access contacts of step (b) based on the occurrence of one or more vault access circumstances; (d) providing, by the processor, the allocated contact(s), with controlled access to the digital vault consistent with the allocations of steps (c), the controlled access includes (i) verifying the identity of a vault access contact and (ii) allowing access for a limited period of time.

In yet another embodiment, a system is disclosed. The system comprises a server system configured to provide limited controlled access to encrypted digital information in a digital vault. The system includes a memory configured to store instructions; and a processor configured to execute the instructions stored in the memory and thereby cause the server system to perform: (a) creating a digital vault of a user comprising storing encrypted digital information of the user at one or more predetermined destination locations; (b) permitting the user to allocate encrypted digital information so as to create one or more digital sub-vaults; (c) permitting the user to allocate one or more sub-vault access contacts with controlled access to one or more sub-vaults; (d) permitting the user to allocate sub-vault access to the sub-vault access contacts based on the occurrence of one or more sub-vault access circumstances; (e) informing any allocated sub-vault access contacts of (i) their status as sub-vault access contacts and (ii) the sub-vault access circumstances; and (f) providing, by the processor, the sub-vault access contact(s), with controlled access to the sub-vault consistent with the allocations of steps (d), the controlled access includes (i) verifying the identity of a sub-vault access contact and (ii) allowing access for a limited period of time.

In yet another embodiment, a system is disclosed. The system comprises a server system configure to provide limited controlled access to encrypted digital information in a digital vault. The system includes a memory configured to store instructions; and a processor configured to execute the instructions stored in the memory and thereby cause the server system to perform: (a) creating a digital vault comprising storing encrypted digital information in one or more predetermined destination locations; (b) permitting the user to allocate one or more digital vault access contacts; (c) permitting the user to allocate digital vault access to the digital vault access contacts based on the occurrence of one or more vault access circumstances; and (d) providing, by the processor, the digital vault contact(s), with controlled access to digital information in the digital vault consistent with the allocations of steps (c), the controlled access includes (i) verifying the identity of the digital vault access contact and (ii) allowing access for a limited period of time.

In yet another embodiment, a method is disclosed. The method includes receiving limited, controlled access to digital information of a user upon the occurrence of a triggering event by (a) initiating notification by an individual to a server system based on information on an identification card of a user subsequent to a triggering event, wherein said server system comprises a memory, and a processor capable of causing the system to create a digital vault comprising encrypted digital information of the user in one or more predetermined destination locations, wherein the system includes at one least vault access contact allocated for access to the vault upon the occurrence of one or more triggering events, and further wherein at least a portion of the encrypted digital information in the digital vault has been allocated for dissemination to the public upon the occurrence of one or more triggering events; and (b) receiving access to the digital information that was allocated for dissemination to the public for the triggering event, wherein the receiving step (b) further comprises providing access to at least one vault access contact for the triggering event.

In yet another embodiment, a method is disclosed. The method includes receiving limited, controlled access to digital information of a user upon the occurrence of a vault access circumstance by (a) receiving notification from a server system informing an individual of (i) their designation by a user as a vault access contact for the user and (ii) at least one vault access circumstance for which they are designated as a vault access contact; the server system comprising a memory, and a processor capable of causing the system to create a digital vault comprising encrypted digital information of the user in one or more predetermined destination locations; (b) receiving notification, from the server system, by the individual, that a vault access circumstance for which they have been designated has occurred; (c) verifying, by the individual, their identity with the server system; and (d) receiving information from the server system previously allocated by the user for the vault access circumstance of step (b).

### BRIEF DESCRIPTION OF THE FIGURES

For a more complete understanding of example embodiments of the present technology, reference is now made to the following descriptions taken in connection with the accompanying drawings in which:

FIG. 1 is a flow diagram of a digital vault lifecycle, in accordance with an example embodiment

FIG. 2 is an illustration of an environment, where example embodiments can be practiced;

FIG. 3 is a flow diagram of a digital vault lifecycle including an authentication sequence, in accordance with an example embodiment;

FIG. 4 is a flow diagram of an example method of certifying the content of the digital vault, in accordance with an example embodiment;

FIG. 5 illustrates an example certificate, in accordance with an example embodiment;

FIG. 6 illustrates an example of a card including a QR code, in this case an emergency wallet card, in accordance with an example embodiment;

FIG. 7 is a flow diagram of an example method of how an emergency vault is used at the time of an emergency, in accordance with an example embodiment utilizing an emergency wallet card;

FIG. 8 is a block diagram of an electronic device, in accordance with an example embodiment;

FIG. 9 is a block diagram of the server of FIG. 2, in accordance with an example embodiment;

FIG. 10 is a flow diagram of an example method of creating an emergency vault, in accordance with an example embodiment; and

FIG. 11 is a flow diagram of an example of a digital vault relating to emergent circumstances, in accordance with an example embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth to provide a thorough understanding of the present disclosure. It will be apparent, however, to one skilled in the art that the present disclosure can be practiced without these specific details. In other instances, systems and methods are shown in block diagram form only to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments

Moreover, although the following description contains many specifics for the purposes of illustration, anyone skilled in the art will appreciate that many variations and/or alterations to the details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the following discussion and in the claims, the terms “including,” “comprising,” and “is” are used in an open-ended fashion, and thus should be interpreted to mean “including, but not limited to.”

Various example embodiments of the present disclosure provide methods and systems for creating and controlling a digital vault, the purpose of the vault to be established by the user. While various vaults will be discussed individually, as will become clear, the methods and systems as described can be used to create and control any digital information that can be stored and secured where the user's release instructions can be authenticated.

In addition, the sequence of operations of the method need not be necessarily executed in the same order as they are presented. Further, one or more operations may be grouped together and performed in the form of a single step, or one operation may have several sub-steps that may be performed in parallel or in sequential manner.

As used herein, “user” refers to the owner of the information contained in the vault and always includes both a single user and one or more joint users should the disclosed digital vault be jointly held. As will be apparent to the skilled artisan, when a vault is held jointly, the joint owners may be specified as the first and/or final contacts depending upon how the user structures the vault contact information. It will further be evident to the skilled artisan that when a vault is jointly owned, each sub-vault may have either a single user or a joint user

The digital information stored in the digital vault can take any form suitable for digital storage with the nature of the information dependent upon the purpose of the digital vault that is being created.

The content may include, but is not limited to, information maintained by the user, e.g., financial information, medical information, estate information, personal information, professional information, business information and other important information maintained by the user. Specific examples of important documents include wills, powers of attorney, living will, and medical documents such as allergy related document and DNR orders.

Moreover, the content can comprise files of creation of the user, e.g., images, audio files, video files, invention disclosures, and written documents such as manuscripts, among other things.

The digital vaults as described don't have to be associated with information that is considered “important” or “confidential.” The digital vaults can be used to store and maintain any type of information including mundane information, for example, household bill payment or pet information. While the precise nature of information maintained in the digital vault is not critical, the information the user places in the digital vault is generally information the user wants/expects to provide to a third party at some point in the future who will receive limited and controlled access to at least a portion of the digital information in the vault. So, for example, in one embodiment, the digital vault can be used by one spouse to maintain and manage day to day household information that might be needed by another spouse should the first be unavailable. The content of the vault need not be a digital file per se, as in one embodiment, the user may create the vault merely to contain the names and contact information of their emergency contacts. By way of example, in this embodiment, the user may create a vault which doesn't release information to a third party but which instead allows a third party to access the names and contact information for the individuals emergency contacts. Similarly, where the user creates a digital vault, the user may also create a vault or sub-vault containing names and contact information for emergency contacts, which contacts can differ from any vault access contacts established by the user. Such a vault or sub-vault may be useful in conjunction with a device for contactless communication, such as a QR code, as discussed below.

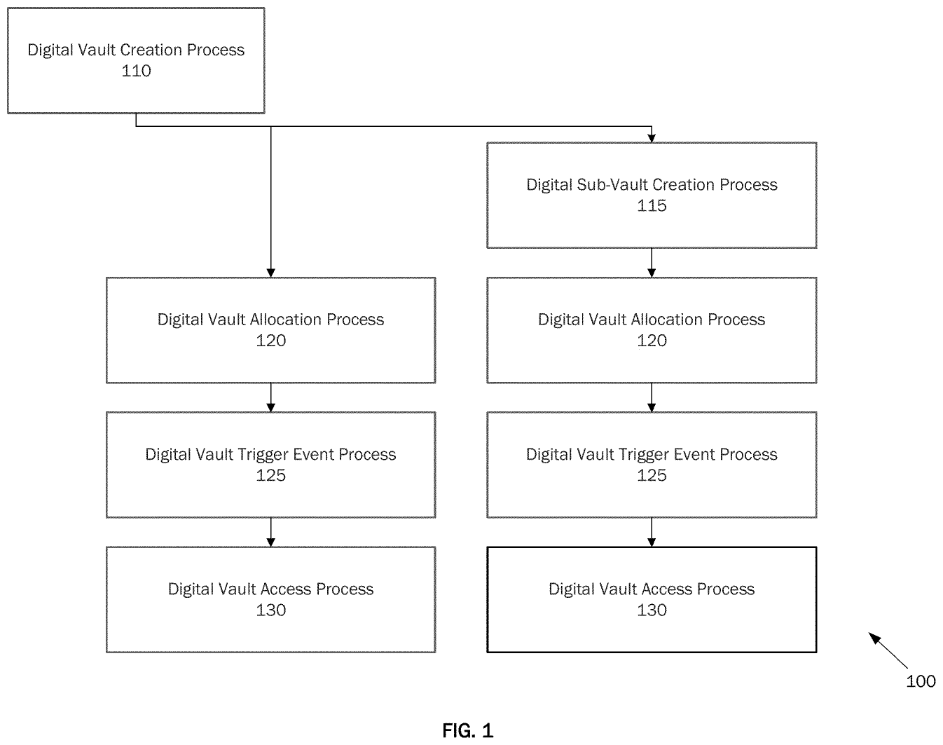

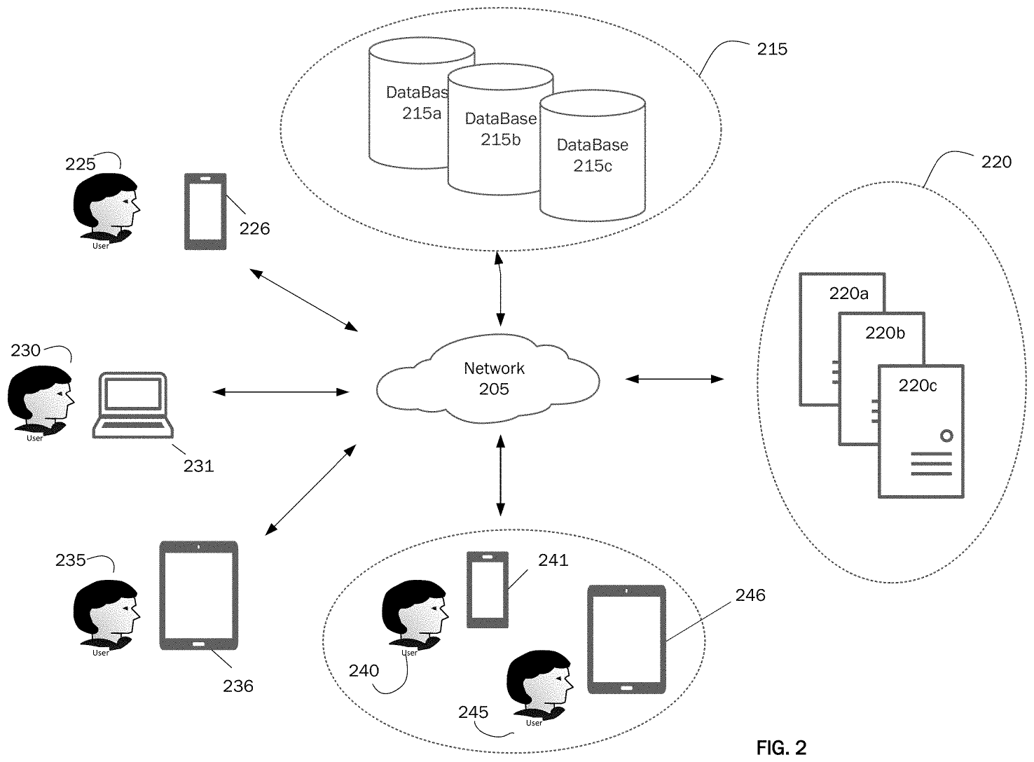

FIG. 1 is a flow diagram 100 of controlled access to information present in a digital vault, in accordance with an example embodiment. The digital information of the user (230 in FIG. 2) is stored in a digital vault and subsequently released via controlled access.

As seen in FIG. 1, the user creates a digital vault via digital vault creation process 110 by uploading digital content of the user 230. The digital information is encrypted upon uploading. The user 230 can then create one or more digital sub-vaults in the sub-vault creation process 115 by allocating encrypted digital information into one or more of the sub-vaults. The user 230 than defines the vault or sub-vault access properties in the digital vault allocation process 120 which includes determining the desired digital vault access contacts for the vault and/or sub-vault and the one or more vault access circumstance(s). Once the digital vault or sub-vault is established, upon the occurrence of the vault or sub-vault access circumstance(s), the system is informed of the vault access circumstance via the digital vault trigger event process 125. Once the digital vault or sub-vault is triggered, access to the vault or sub-vault is provided via the digital vault access process 130 consistent with the allocated properties established in process 120.

In an embodiment shown in FIG. 2, the servers 220 and the databases (215a, 215b, 215c referred to herein as 215) are distributed and decentralized. In at least one example embodiment, the server (220a, 220b, 220c referred to herein as 220) can be a single computing system in which a local drive or a shared drive may be stored. The network 205 may be centralized or decentralized network or may comprise a plurality of sub-networks that may offer a direct communication between the entities or may offer indirect communication between the entities. Examples of the network 205 include, but are not limited to, the Internet, local area network (LAN), wide area network (WAN), wireless, wired, and the like.

In connection with the various embodiments, the user 230, digital vault access contacts 225 and 235 and third parties 240 and 245 whose roles can vary depending on the embodiment, may each have one or more communication devices for communicating among themselves or with the network. In an example, the user 230 has a device 231, the third parties 240 and 245 have devices 241 and 246 and the access contacts 225 and 235 have devices 226, 236, respectively. Examples of the devices 226, 231, 236, 241, and 246 are not limited to mobile phones only, and the devices 226, 231, 236, 241, and 246 may take the form of any portable electronic device (e.g., laptops, smartphones and tablets, radio receivers, wireless communicators) having cellular and/or WIFI communication capabilities. For instance, the devices 226, 231, 236, 241, and 246 may be equipped with subscriber identity module (SIM) or Removable User Identity Module (R-UIM) to enable cellular communication.

The user 230 has digital information recorded or stored in a digital vault. The digital information can correspond to files containing images, music and documents comprising personal and business information of the user 230. In an embodiment, the digital information in the digital vault can be remotely stored in the server 220 and/or the database 215. In another embodiment, the digital contents of the digital vault are stored in the local drive or the shared drive of the single computing system.

During operation, a user 230 can employ a computer system to create a digital vault for holding digital information. In this embodiment, the new content can be uploaded, encrypted, and stored in at least one predetermined destination location. The precise technique for uploading and encrypting the digital information is not critical to this invention and can include those techniques recognized in the art.

In one exemplary embodiment, an ultra-security file storage module disclosed in U.S. patent application Ser. No. 16/695,182 filed Nov. 26, 2019, employs randomized logic to effectively slice encrypted or unencrypted files to create slices of the files and store the plurality of slices at different destination locations (e.g., the servers 220a, 220b and 220c and/or the databases 215a, 215b, 215c).

For example, the '182 application discloses a process where files associated with the digital contents of the digital vault (of a user) are first sliced into one or more slices and then the one or more slices are stored at local, shared or distributed storage space associated with the digital vault. The slicing of the files provides an extra layer of security to the digital contents of the digital vault.

An exemplary process disclosed in the '182 application includes receiving, by the processor, the file associated with the user; performing, by the processor, slicing of the file into one or more slices based on a randomization logic; storing, by the processor, the one or more slices of the file in one or more predefined destination locations; updating, by the processor, a metadata file associated with the file; updating, by the processor, an audit log maintained for the file. The method further includes performing, by the processor, stitching of the one or more slices of the sliced file for retrieving the file stored in the digital vault, upon receiving a request for accessing the file.

The embodiments disclosed herein are not limited to any particular uploading and encryption method. Any art recognized technique for uploading and encrypting digital files can be employed in the embodiments of the present invention. To that end, suitable techniques in addition to those outlined above are recognized in the art and need not be described in detail here.

While the foregoing embodiments have been described in terms of a single digital vault, the digital information in the digital vault that can be allocated into one or more digital sub-vault. For example, as seen in FIG. 1, one or more sub-vaults each of which include at least a portion of the information stored in the digital vault can be created. It is important to recognize that digital information is not exclusively required to be limited to a single sub-vault. That is, the same information can be associated with one or more sub-vaults.

The sub-vaults can be created or modified by the user 230 at any time. For example, the user 230 can allocate the digital information to sub-vaults after being uploaded into the vault or the user 230 can set parameters such that the information is automatically distributed to the sub-vaults upon uploading.

As will be seen, the sub-vaults can be created based on the information they contain or for some commonality of purpose. For example, the sub-vaults can relate to the same type of digital content, e.g., financial, travel, photos, or music files. In addition, the sub-vaults can include digital content of a common purpose, e.g., medical information, financial information, or family memories. The user 230 does not have to designate any particular purpose for a sub-vault.

The sub-vaults can also be created based on their relationship to certain vault access circumstances. Vault access circumstance comprise those circumstances which have been selected by the user 230 to start the controlled vault access process. The vault access circumstances can be defined in terms of the occurrence of an event, i.e., a triggering event, or in terms of a predetermined date and/or time.

To this end, the user can also designate certain information for public availability and/or dissemination under certain vault access circumstances. In the context of this invention, by “information for public availability and/or dissemination” it is meant information that the user allocates for availability and/or dissemination to third parties who are not vault access contacts, upon the occurrence of a predetermined vault access circumstance. For example, where the vault access circumstance is an automobile accident, such information may include medical-related information of the user. To that end, information for public availability and/or dissemination is not typically accessible to the public outside of the vault access circumstances.

One class of vault access circumstances are triggering events. By triggering events, it is meant any event which the user 230 has designated as providing for limited, controlled access to the digital vault or one or more sub-vaults.

One class of triggering events are exigent events, i.e., any event where access to information in the vault is urgently needed to assist the user 230. Put another way, the triggering event could be any situation where the user 230 may need to reach out for assistance. These events can occur during everyday life-in the home, at work, in automobiles, in homes, in schools, daycare centers, and in other public areas, for example, shopping in stores or malls, at entertainment events including amusement parks, stadiums and parking lots. Alternatively, the triggering event can occur during travel, e.g., cruises, air travel, train travel, hotels, camping grounds, amusement parks, among others.

Specific classes of exigent triggering events include emergencies, such as both life threatening and non-life threatening emergencies. These include emergencies of a personal nature such as an automobile accident, illness, or other medical event. The exigent events can also be of a business or financial nature, such as malware or ransomware attack or financial theft.

Alternatively, triggering events can include those events of non-personal nature, such as community emergencies—fire, forest fires, prison escapes, bombs, floods, earthquakes, weather events such as flooding, hurricanes, and tornadoes.

Vaults and sub-vaults associated with exigent circumstances can include information for public availability and/or dissemination discussed above. Specific examples of such information may include powers of attorney (POA), wills, insurance documents, medical information, and instructions such as allergy information, DNR orders and the like. Documents maintained in the vault can be released when necessary.

In another aspect, the vault access circumstance can be a predetermined date or time in which the user 230 allows access to information in the vault. To this end, the vault access circumstance is not necessarily of an exigent nature and instead can be planned in advance. In these embodiments, the vault access circumstance can be identified by a specific time or date, e.g., January 1, or by a specific event, e.g., a wedding, a graduation, a birthday, a birth, or death.

As discussed above, the user 230 can define the vault access circumstance for which they wish to allow access to the vault or sub-vaults. In this regard, the user 230 can allocate all or a portion of the digital information in the vault to one or more vault access circumstances. Alternatively, the user 230 can allocate one or more sub-vault, or even portions of one or more sub-vaults, to each of the vault access circumstances.

In other words, the user can designate the partial or total distribution of a digital vault or digital sub-vault information depending upon the vault access circumstance. As discussed above, the user can also designate certain information as information for public accessibility and/or dissemination, when allocated to certain vault access circumstances.

In addition to allocating information and/or sub-vaults to vault access circumstances, various embodiments of this invention also provide for the user 230 to be able to allocate a number of properties to the vault or sub-vault in order to establish the purpose of the vault or sub-vault, and to provide parameters for access to the vault or sub-vault by third parties. These properties include who can access the vault, how much and/or which portions of the vault or sub-vault they can access, when they can access the vault or sub-vault, and how long that vault or sub-vault access can occur.

In all embodiments of the invention, the user 230 allocates one or more digital vault access contacts who are eligible for controlled, limited access to the digital vault.

In one aspect of this embodiment, these vault access contacts 225 and 235 can include family members, friends, and business associates. Moreover, these individuals can be specifically named by the user 230 or can be identified by their name or even their relationship to the user 230, e.g., an attorney, CPA, insurance agent, and the like.

The scope of digital vault contacts is limited only by the ability of the user 230 to adequately describe the contact such that their identity can be confirmed by the system prior to providing access to the vault.

According to one embodiment, the user may define more than one class of vault access contacts. The classes can include, e.g., primary, and secondary vault access contacts, and the determination as to when each class is contacted can be set forth by the user.

For example, a user might create a digital vault or sub-vault and designate a partner or spouse as a primary vault access contact and their adult children as a secondary vault access contact. In this example of this embodiment, the primary contact, in this case, the spouse, would be notified first upon the occurrence of a vault access circumstance, but the secondary contact, in this case, the adult children wouldn't be notified unless the spouse was unavailable. It will be apparent to the skilled artisan that the manner in which the contacts are designated can be adjusted as desired by the user or by a system administrator.

As shown in FIG. 2, digital vault access contacts 225, 235 are authorized to access at least a part of the digital vault, including one or more sub-vaults, based on a degree of access provided by the user 230.

The access is defined both in terms of which information is available and the manner in which the vault can be accessed. The access that is granted to the vault access contacts 225 and 235 can be provided by the user 230.

The information which can be accessed is designated by the user 230 in terms of the vault or sub-vault access. In one example, the user 230 allocates information related to one or more exigent events to a sub-vault. Another example relates to the allocation of audio and/or video files by the user 230. The user 230 can further allocate this information by type of file or theme.

The manner in which the vault access contacts 225 and 235 can access the vault and interact with the contents, includes, but is not limited to, the following modes of access: full access mode, a contribute mode, an edit mode, and a read-only mode.

The full access mode allows the vault access contact 225, 235 access to all digital content allocated to that contact or that triggering event in the digital vault or sub-vault.

The contribute mode allows the digital vault access contacts 225 and 235 to add digital content/files to the digital vault or sub-vaults, but no provisions exist for editing/deleting digital contents in the digital vaults. An example of contribute mode would be the ability to add photos to a sub-vault containing photos from the user 230.

The edit mode permits the digital vault access contacts 225 and 235 to edit the digital contents of the digital vault or sub-vault.

The read-only mode permits the digital vault access contacts 225 and 235 to view the digital contents of the digital vault or sub-vault.

The method for allocating the vault access contacts by the user 230 can be dependent on the user, the individual vault access contact or group vault access contact being allocated and the digital information subject to release. In one embodiment, the user 230 identifies and assigns digital vault access contacts, such as the digital vault access contacts 225 and 235, employing the computer system.

The method of designating vault access contacts can vary depending on the type of contact. In one embodiment, the digital vault access contact is, e.g., a named individual where the user 230 provides suitable information about the user 230 to allow the system to verify the identity of the contact when necessary. Such information can include photographs, personal information and government issued identification documents such as driver licenses.

Also, access credentials for the access contacts may be employed. Examples of suitable access credentials include log in information such as username, access code, web link among others.

Biometric forms of identification may also be employed in verifying the access contacts. In the context of this embodiment, biometric verification of identity relates to the measurement of a person's physical features and characteristics to prove a person's uniqueness and verify their identity. Examples of biometric encryption techniques include the use of facial recognition, fingerprint scans and eye, e.g., retinal or iris, scans.

Where biometric-based identification is employed in verifying the vault access contact, prior obtaining and saving of data relating to biometric characteristics of the person in question, e.g., an eye-scan or a fingerprint scan, is typically employed.

With reference to FIG. 2, the user 230 provides access to at least a part of the digital vault to digital vault access contacts 225, 235. The digital vault access contacts 225, 235 can be allocated to access at least a part of the digital vault based on a degree of access provided by the user 230 via the devices 226, 236, respectively.

While the process of allocating vault access contacts can be performed by the user 230 online, the user 230 and/or the digital vault access contact can opt for a more formal arrangement. This option may find particular usefulness where the digital information to be accessed by the digital vault access contact is of sufficient uniqueness or value. Such a process may be used, for example, for a will or an invention disclosure document.

In this embodiment, the user 230 allocates access to the digital vault access contacts by executing one or more allocation documents in a virtual presence of third parties 240 and 245, such as a notary, e.g, third party 240 and the witness, e.g., third party 245. It must be noted that the witness 245 and the notary 240 are shown for example purposes only and one or more witnesses and notaries may or may not be required for signing the one or more allocation documents. Moreover, the allocation documents may be signed either electronically, physically or a combination of virtual and physical presence of the user 230, the third party notary 240 and the third party witness 245. For example, the user 230 may be present in a remote location and may sign allocation documents electronically whereas the notary 240 and the witness 245 may physically sign the allocation document in the virtual presence of the user 230.

One example of an exemplary technique for the execution of documents, such as allocation documents establishing digital vault access contacts, can be seen in US Patent Application Publication US2019/014754A, to CHINTALA et al, published May 16, 2019.

This published application discloses a method which comprises receiving, by a processor, an event request from a user. The event request can comprise one or more documents and information related to one or more testifiers and a legal authority. The method also includes upon receiving the event request, creating, by the processor, an event for an execution, and optional, authorization session. The participants of the event can include the user, the one or more testifiers and the legal authority.

The method also includes facilitating, by the processor, access to the execution session for participants of the authorization event either physically or virtually via respective electronic devices. The method includes provisioning, by the processor, an option for the legal authority to record the authorization session when the participants are present for the session. The method further includes verifying, by the processor, identity of the participants of the authorization event. The method includes sending, by the processor, a request to the participants to sign the one or more authorization documents either electronically or physically. The method further includes terminating, by the processor, recording of the authorization session after the participants sign the one or more authorization documents. The method includes storing, by the processor, the recording of the authorization session and the one or more authorization documents.

In one exemplary embodiment as disclosed in the application, the user 230, a notary 240 and a witness 245 may access a tool/platform (e.g., a live-sign application), on their respective devices, facilitated by the server 220 for creating an allocation session. The allocation session can include a process of signing the allocation documents by the user 230, the witnesses 245 and the notary 240 as part that may be recorded and stored in the digital vault or sub-vaults.

In a non-limiting example, the live-sign application may be a web application. In another example, the live-sign application may be a mobile application. The devices 226, 231, 236, 241, 246 may access an instance of the live-sign application from the server 124 for installing on the devices 226, 231, 236, 241, 246 using application stores associated with Apple iOS™, Android™ OS, Google Chrome OS, Symbian OS®, Windows Mobile® OS, Windows Phone, BlackBerry® OS, Embedded Linux, web OS, Palm OS® or Palm Web OS™, and the like. Alternatively, the live-sign application may be installed as a stand-alone application on a stand-alone device, such as the devices 226, 231, 236, 241, 246.

In another embodiment related to individual contacts that are designated by name, the digital vault access contacts 225 and 235 can be informed of the user's allocation and, optionally, confirm their acceptance of their status as digital vault access contact prior to being able to access the digital vault and/or sub-vaults.

In an example of this embodiment, the digital vault access contacts 225 and 235 participate in a confirmation process that is initiated by the user 230 or by the system (application). The confirmation process ensures that the user 230 and/or digital vault access contacts 225 and 235 are both aware of the status of the digital vault contacts.

If any of the digital vault access contacts 225, 235 fail to respond to the confirmation sent by the user 230 or the system, the server 220 can sends e-reminders to the digital vault access contact who failed to respond. The user 230 or the system can also set a maximum number of reminders to be sent to a digital vault access contact who fails to respond to the confirmation. At the end of the confirmation process, the user 230 can choose to either retain the digital vault access contact 225 or replace the digital vault access contact 225 who fails to adequately respond.

In addition to allocating the digital vault access contacts, access to the vault is controlled temporally. That is, the user can set a time limit for access to the vault. The time limit can differ depending on the triggering event or the contact in question.

The time limit can be set by the user at any time, alternatively, the system can provide a default time limit for all triggering events, or which can depend on the nature of the triggering event. In addition, a default time limit can be set where the user chooses not to set a time limit for each access contact.

The user can also designate one or more vault administrators who are capable of ascertaining the status of the vault and/or sub-vaults at any time, as well as the availability of the vault access contacts.

To this end, the system can establish an automatic check-in process such as that disclosed in US Patent Application Publication US2019/014754A, to CHINTALA et al, published May 16, 2019.

In an example embodiment, the vault access contacts participate in a check-in process that is initiated by the user or by the system (Application). The check-in process ensures the ongoing availability of the user and/or access contacts. The user or the system (Application) creates the check-in process and presets options for the check-in process, such as, frequency of alerts and number of electronic reminders. The check-in process is an automatic process that runs on the server and promptly notifies the user and/or the contacts upon violation of rules in the check-in process. For example, the user or the system (Application) may set a weekly or monthly check-in trigger for sending a check-in notification to the user and the access contacts. The user and the contacts have to respond to the check-in notification that is sent. Whenever the user or the contacts respond to the check-in trigger by checking in, a data log is updated with a time stamp that corresponds to a time in which either the user or the contacts checked in.

The vault administrator can have the ability to override the system as well as act as a fail-safe. The vault administrator can also have powers and responsibilities related to access to the vault. For example, the vault administrators can have the ability to close the vault and/or sub-vaults at any point during the process. In addition, for example, the vault administrator may have the authority to access information such as medical files that are not in the vault. The vault administrator, if so, authorized in advance by the user, may be able to incorporate such information with existing vault data.

Vault administrator(s) can be allocated at any point of time in the vault creation or allocation process. Moreover, the vault administrator(s) can be allocated in the same manner as, e.g., vault access contacts. As discussed above, the user can designate, e.g., secondary access contacts, or can even designate the vault administrator to handle the release of information in the event no designated vault access contact is available. According to one embodiment, the system can require a designated vault administrator and if none is provided by the user, the system administrator can act as the vault administrator.

Once the digital vault is fully authorized in step 120, the user 230 can change and/or update the digital information and contacts until such time as a triggering event 125 occurs. Once a triggering event occurs as further described in FIG. 1, the digital vault informs the designated contacts and then the digital vault access process 130 as further described in FIG. 1 is carried out such that the designated content is made available to digital vault access contacts for a predetermined time-period.

While the foregoing is largely discussed in terms of the digital vault, it must be recognized that where sub-vaults are employed, each sub-vault is an independent vault with its own contacts, controls and uses. Each sub-vault will be subject to its own contact assignment and management process 120 in FIG. 1.

As discussed previously, the digital information that can be stored in digital vault is not limited in scope by type or content. Where the digital information to be stored has a large monetary or intrinsic value to the user, it may be desirable to be able to corroborate that the digitally stored information is authentic.

One technique for establishing authenticity is to authenticate and corroborate the digital information prior to uploading the information.

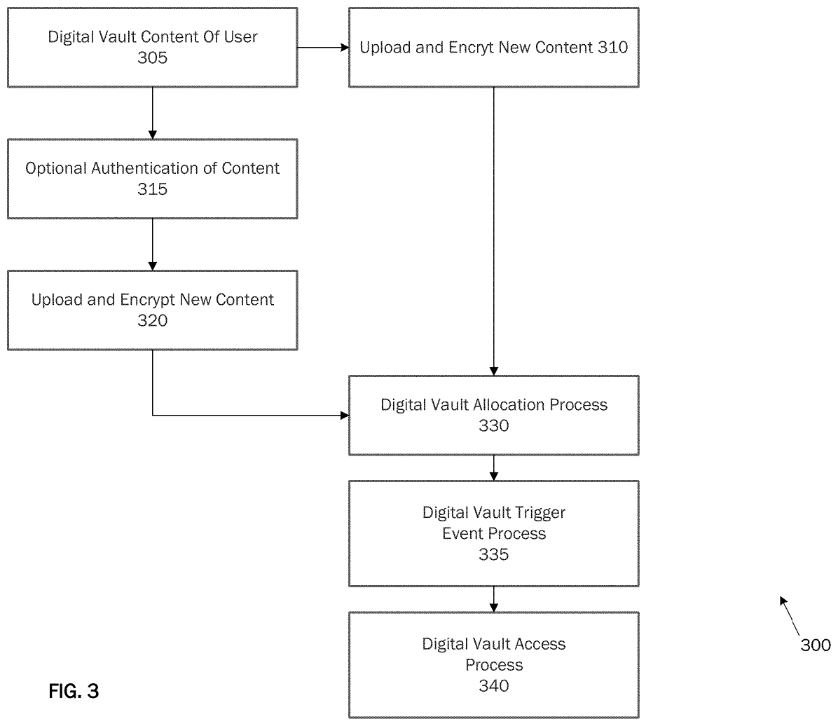

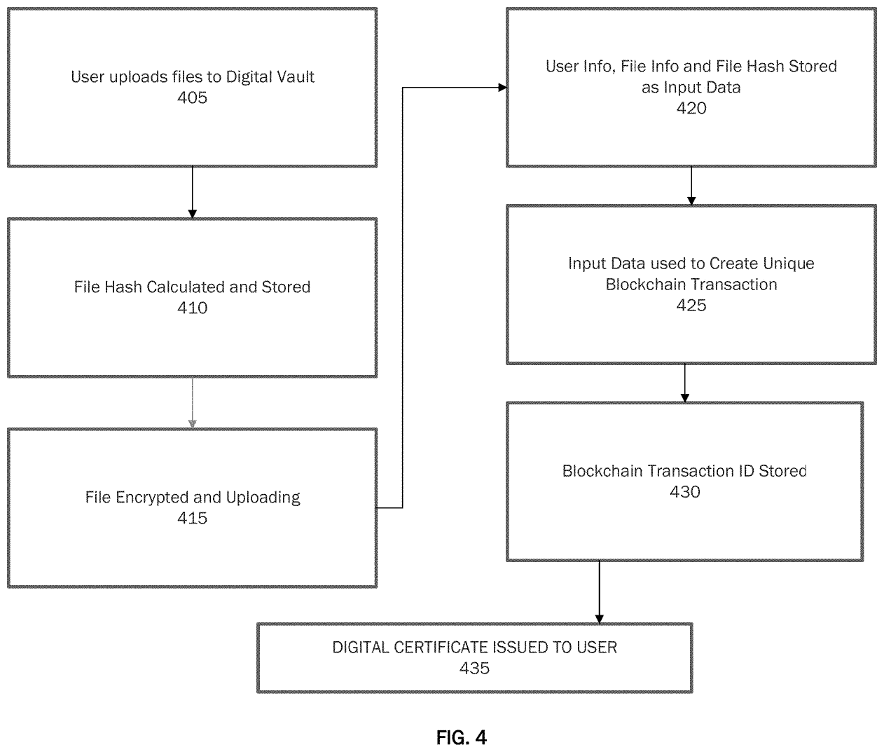

FIG. 3 is a flow diagram 300 of a digital vault lifecycle including an optional authentication of the digital content at the time of its deposit, in accordance with an example embodiment. In this embodiment, the content can be subject to system certification as further described in FIG. 4 or can be authenticated by a designated third party, for example, a notary.

Once the content is uploaded, the user 230, can choose to proceed with a process 315 wherein the newly uploaded contents will be authenticated. As seen in FIG. 3, the user 230 upload the vault content via process 305. Normally, the content is uploaded and encrypted via 310 prior to the user carrying out the digital vault allocation process 330, digital vault trigger process 335. However, if the user 230 desires authentication of the vault contents, that authentication can be carried using any art recognized method, e.g., witnessing by one or more third parties, notarization, or digitation certification. If authentication is carried out, the user's digital information along with a digital record of the authentication is uploaded and encrypted in 320 prior to the user carrying out the digital vault allocation process 330.

One example of this aspect of the invention shown in FIG. 4. The authentication includes certifying by the processor, one or more of the digital files 405 prior to encrypting and uploading 415, wherein certifying comprises (i) generating a file hash 410 for the uploaded digital file, (ii) generate input data 420, where the input data can include user information, file information and the file hash 410, (iii) creating a blockchain transaction 425 from the input data, and (iii) storing 430 the transaction id for the blockchain transaction.

Storage of the transaction id or the blockchain transaction 430 can be performed in the same manner as the storage of the digital file 415. Insofar as encryption processes, file hash processes and blockchain transactions are recognized in the art, they need not be described in detail here.

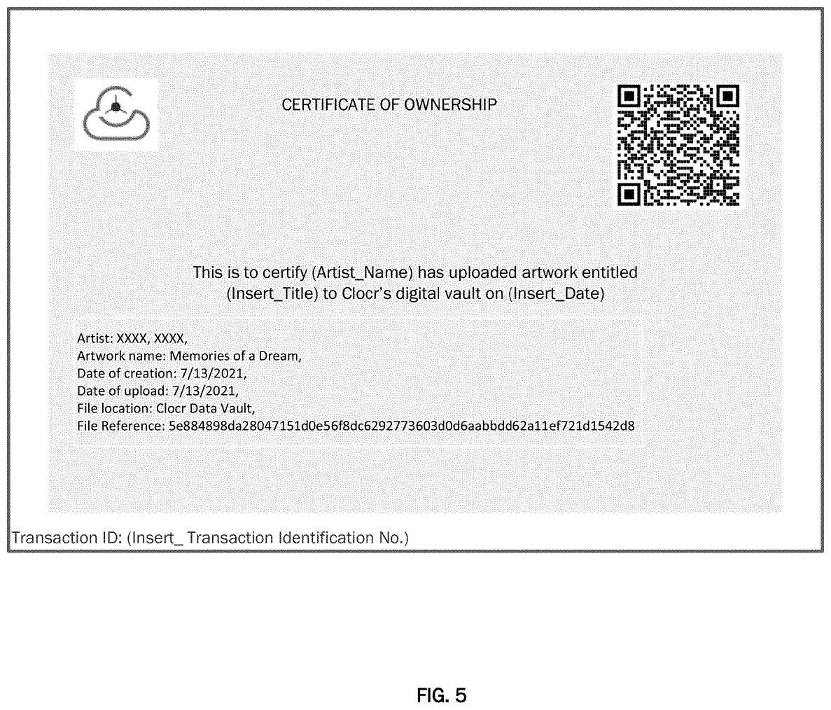

Subsequent to storage, a digital certificate can be issued 435 such as that exemplified in FIG. 5. The digital certificate can be a physical document that includes information, including, but not limited to, file information, user information and upload information. An electronic copy of the digital certificate can also be separately stored in the digital vault, if desired.

The authorization event does not mandate either the actual or virtual presence of the participants (e.g., user, notary, contacts, and/or witnesses), in fact, one or more of the participants can be physically present in the room and one or more can be virtually present during authorization. Moreover, authentication can be done by a third party directed by the user, a notary, or by a designee provided by the holder of the digital vault.

Where performed virtually, access credentials may be employed, which credentials may include log in information such as username, access code, web link and the like for virtually participating in the authorization event.

Where a virtual authentication certification event 200 including the execution of document is performed, video conferencing can be set up amongst the notary 240 (FIG. 2), the user 230 and the one or more witnesses (e.g., third party witness 235) for viewing the authorization session indicated by the authorization event. The third-party notary 240 verifies identity of the user 230 and the witness 235 prior to recording the authorization session. In an embodiment, the notary 240 initiates recording of the authorization session upon displaying the authorization document and the live-sign document (existing documents) for the user 230 and the witness 235 and requests the user 230 to sign the authorization document(s). The witness 235 is then requested to sign the authorization documents. The notary 240 verifies the signatures and signs the authorization documents. The signatures during the authorization session may be either electronic or physical.

Additionally, or alternatively, any existing document pertaining to the authorization document can also be uploaded to the live-sign portal. In this regard, the existing document is processed and converted so as to be appended with the authorization document created by the user 230.

In addition to the creation of the digital vaults and sub-vaults, embodiments of the invention also include the ability to provide controlled, limited access to the digital vault by vault access contacts.

Exemplary methods for providing access to the vault may start with the computer system receiving notification of the occurrence of a vault access circumstance.

The exact form of the communication is not critical as long as it is capable of informing the system of the occurrence of a vault access circumstance. Moreover, this notification can come from outside of the system, or it can be programmed into the system where the circumstance is, e.g., a predetermined date and/or time.

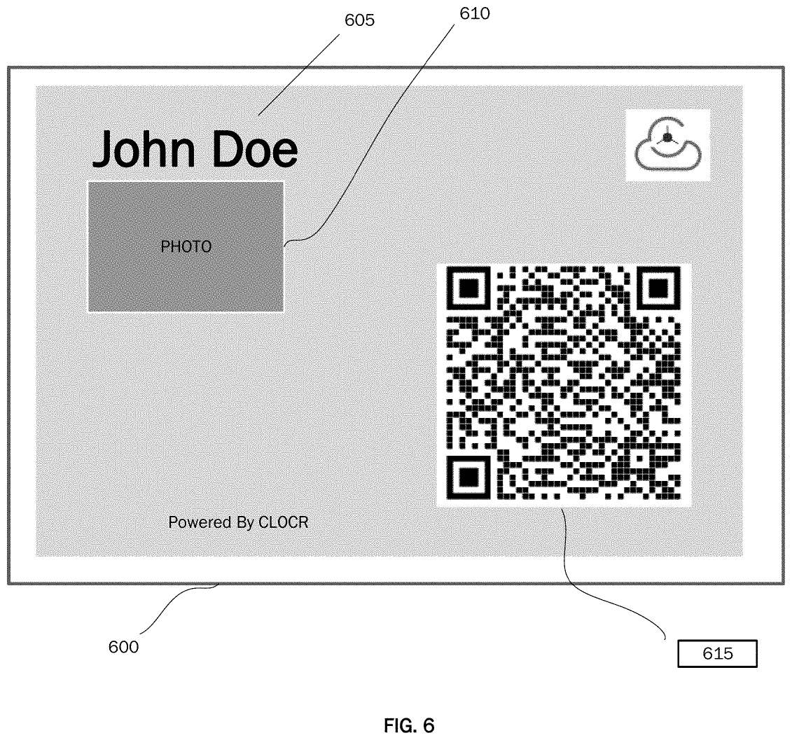

In one example of this embodiment in which the notification is external, the processor receives the notification that is initiated based on information on a “card” 600 in the possession of the user 230. An example of this card is shown in FIG. 6.

This card 600 can be a physical card, e.g., an identification card carried by the user 230, or a digital card located on, e.g., a mobile electronic device of the user 230. The information on the card 600 can comprise identifying information of the user 230, such as name 605 and photo, 610. In addition, the card 600 includes, for example, a phone number or a contactless communication device such as a QR (quick response) code 616, which can start the notification process.

QR Codes may be employed to provide a variety of information associated with the use. For example, the QR code may provide access to a vCard of the user that includes a phone number to connect to the computer system, which itself can be person attended or an interactive voice response (IVR) system. The QR code can also provide the third party with a unique identification code for this user, which code can be used to start the vault access process.

The QR code can also provide a link to, e g., a web page set up by the user to provide exigent information of the user. This is one example of a technique for providing public availability and/or dissemination of predetermined information of the user.

According to one embodiment, multiple QR codes can be included on a wallet card or on a user's mobile device. For example, in one embodiment, one QR code can provide information appropriate to emergency response personnel, including current medical conditions, medications, allergies, a DNR, while a second, different, QR code may be presented providing information for a doctor or hospital which also includes for example, insurance cards, etc. The number, description, and uses of QR codes are as varied as the users who can use the system. In one embodiment, the system can include an initial QR code that requests the identity of the individual in possession of the user's mobile device and in one embodiment the system may provide a return QR code depending upon who has the device. In this embodiment, if the third party is not an emergency responder and has merely found the mobile device, the system can provide a QR code that is limited to contact information for the user to enable return the device. According to one embodiment, if the third party is emergency personnel, the system can authenticate the third party and based upon instructions from the user the system can provide different public information to different emergency response personnel. In one embodiment, if the individual is a good Samaritan, but not emergency personal, the system can record the identity of the third party and release a more limited vault of information, for example, only medical conditions and allergies rather than a full medical profile that a first responder would obtain. Controlling distribution of personal information can be as limited or as extended as defined by the user.

Other forms of contactless communication, such as a Bluetooth device or near field communication (NFC) device can also be employed. Bluetooth and near field communication share several features, both being forms of wireless communication between devices over short distances. NFC is limited to a distance of approximately four centimeters while Bluetooth can reach over thirty feet. The latest development in Bluetooth technology, Bluetooth low energy (BLE), is targeted at low power consumption and uses even less power than NFC

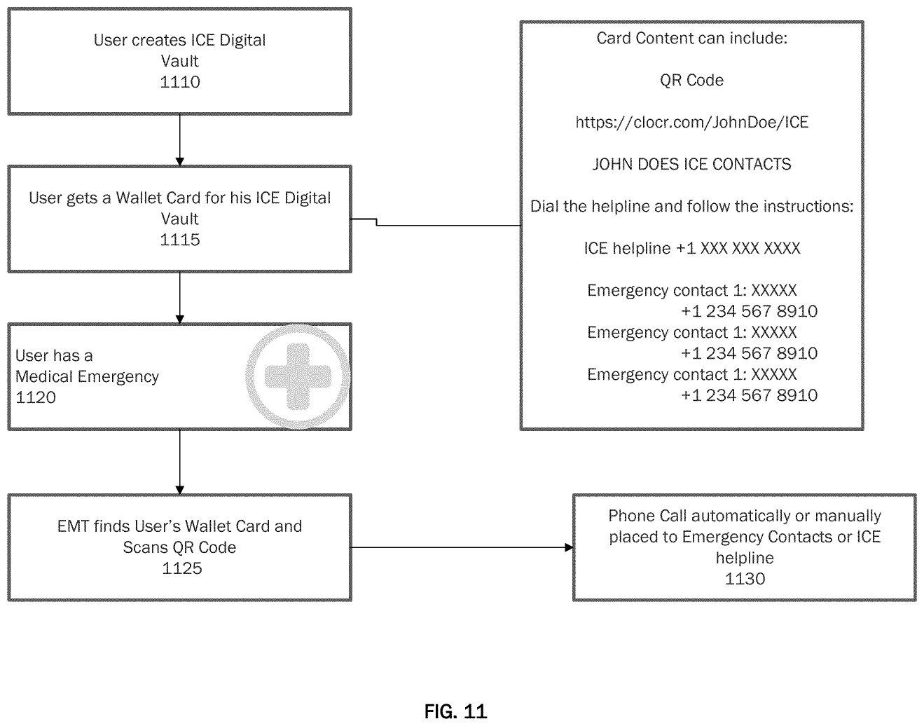

In one example of this embodiment employing a QR code shown in FIG. 11, a user has set up a digital vault. In the embodiment described, the user carries a wallet card 1115. When the user has a triggering event, in this case a medical emergency 1120, a third party, such as an EMT or bystander, arrives at the scene and locates the wallet card 1115 and scans 1125 the QR code 615 (FIG. 6).

The scanning 1125 can be performed by any technique recognized in the art, such as a mobile electronic device which includes an application capable of scanning the QR code 615. In one embodiment, scanning the QR code 615 can result in a notification 1130, a phone call or text can be automatically routed, by, e.g., the computer system, to a mobile phone, or computing device of one or more of the vault access contacts.

As is also shown in this embodiment, upon scanning the code 615, information, and in particular, exigent information can be shown on the electronic device that performs the scan and/or, where the QR code is present on an electronic wallet card of the user, on the user's electronic device. In one aspect of this embodiment, the information can include a phone number, which allows the third party to notify the system 1130.

As seen in FIG. 11, the QR code can allow for dissemination of additional information, such as the information for public availability and/or dissemination discussed above. In this regard, the third party may access information the user 230 has designated as public information for the targeting event.

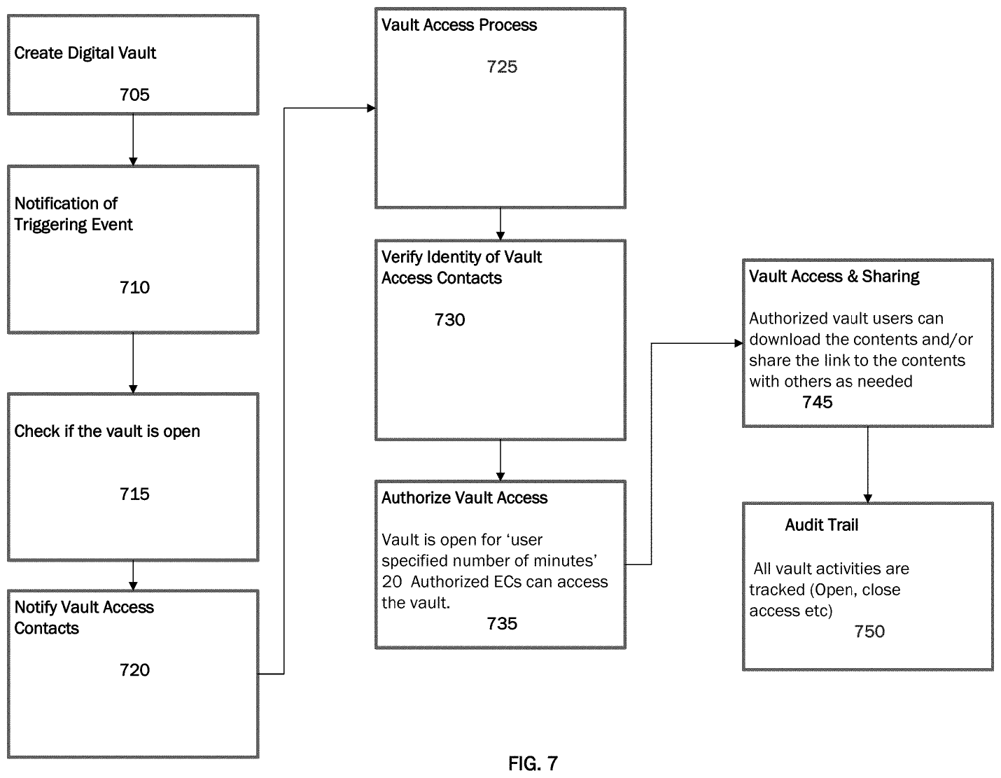

In one embodiment as described, FIG. 7 shows actions that occur subsequent to creation of the vault 705 from notification of the system 710 that a triggering event has occurred through to vault access and beyond. While the following embodiment is discussed in terms of a triggering event, it is applicable to other vault access circumstances.

The notification to the system initiates a series of actions by the system which can include checking the immediate status of the vault 715, notifying 720 the vault access contacts allocated for the triggering event and starting the vault access process 725 for the vault access contacts. However, the precise actions and the order in which they occur can depend upon who makes the initial notification and the nature of the event. For example, where the notification is from a vault access contact allocated to the triggering event, the system can start the vault access process while notifying any other vault access contacts of the triggering event. However, where the notification is performed by a third party, the system can alternatively start the vault access process by contacting the vault access contacts allocated for the triggering event.

In one embodiment, where the triggering event relates to an emergency requiring assistance for the user, the system can contact an Emergency Response Center. The Emergency Response Center, also known as Public Safety Answering Point (PSAP), can be contacted by dialing a specified emergency phone number (e.g., 911 in the U.S.), and then informing the person who answers the phone of the triggering event. Emergency phone numbers vary from region to region and country to country. In the context of vaults for emergent purposes, the Emergency Response Center can be designated to receive the information for public availability and/or dissemination or can even be allocated as a vault access contact by the system.

While the precise events may vary depending on the triggering event, subsequent to receiving notification of the triggering event, the computer system notifies the digital vault access contacts 720 about the triggering event.

Notification of the individual vault access contacts can comprise, e.g., placing calling or sending a text to the allocated individual vault access contact(s).

If the designated notification method 720 does not provide for immediate confirmation of the triggering event by the vault access contact, such as a text or a voice message, then the server may resend the message/call to the digital vault access contact.

These notification steps 710 and 720 can be coordinated to facilitate communication. For example, if a third party notified the system, the digital vault access contacts can be put in contact with that individual to ascertain, e.g., the status of the user and the triggering event.

In one example, where the initial notification 710 of the computer involved a phone call, notification of the access contact 720 can involve forwarding, by the processor, the phone call to one or more of the individual vault access contacts allocated to the triggering event.

In addition to contacting the vault access contacts, the system can notify a vault administrator. As discussed above, the vault administrator can be allocated with a variety of responsibilities by the user including acting as a fail-safe. For example, the vault administrator can close the vault upon being notified that the triggering event was erroneous or being notified by the user that the event has passed, and the vault should be closed. Likewise, the administrator can close the vault upon request from the vault access contacts. Administrator closures of the vault can override the defined time period that the vault was scheduled to be open.

In addition to notifying the vault access contacts, the system provides for access to the allocated information from the digital vault or sub-vault to the vault access contacts or their designees.

Prior to providing access to the vault, the system verifies 730 the identity of the vault access contact, with the precise method of verification of the digital vault access contacts 240, 245 (FIG. 2) being dependent on the vault access contact as well as the nature of the triggering event.

The precise verification technique is not critical to this embodiment and can involve any art-recognized technique. As discussed previously, biometric based verification techniques can be employed.

One example of a suitable biometric technique is known as Live ID or “selfie” verification. This technique utilizes facial recognition and compares the individual being identified to a photo on government-issued id such as a driver's license. When employing such techniques, it may not be necessary to prior save biometric data of the contact. According to one embodiment, this technique may be used with emergency response personnel or even in the event of a good Samaritan who may be required to show a driver's license and a selfie for authentication before any medical or personal information will be released.

It is important to recognize that a variety of authentication factors may also be employed in verifying the identity of the contact. In this regard, examples of suitable authentication factors comprise: (i) something physically possessed by the vault access contact—a physical object in the possession of the contact, such as a security token (USB stick), a bank card, a key, an identification card, and the like; (ii) something known by the vault access contact—this includes knowledge only known to the contact, such as a password, PIN, and the like; (iii) some physical attribute of the vault access contact—this includes biometric characteristics of the contact, such as the scan of a fingerprint, retina, voice, and the like; and (iv) some factor associated with the location of the vault access contact. This includes the connection to a specific computing network or using a GPS signal to identify the location.

In order to provide added security, the use of multi-factor authorization, i.e., more than one of the foregoing authentication factors, can be employed. Multi-factor authorization in this context can include more than one authentication factor of the foregoing for a single individual or one or more authentication factors for multiple individuals. In the latter case, verification may require information from more than one individual vault access contacts. The precise authentication factor(s) employed in any case, however, is not critical to these embodiments.

Subsequent to verification 730, the system provides for access 745 to the allocated digital contents of the digital vault or sub-vault. The digital information can be accessed by user, the digital vault access contact or even a third party designated by the user or access contact.

The exact method of providing access 745 by the system, to the allocated digital information is not critical to the embodiments described and can be dependent on the nature of the material and the triggering event. For example, during certain exigent situations, access 745 can include providing at least a portion of the digital material may be accessed in a format suitable for a mobile electronic device.

Alternatively, certain information, such as a medical power of attorney, may ultimately need to be provided in a physical form. In fact, where the digital information has been authenticated prior to, or during, uploading, access may require providing an electronic copy of the information and/or a physical copy for review. Thus, the access process 745 can include permitting, by the processor, the downloading of digital information from the digital vault.

The digital vault triggering event can be further tracked, e.g., recorded 750 by the system and stored as a record for future reference. It should be noted that the digital vault access process does not mandate remote participation of digital vault access contacts, the contact can be physically present with the user during the triggering event. Moreover, it does not require that the user be unavailable during digital vault access.

While the foregoing embodiment are discussed as processes, the invention also includes system and machine-readable media, that have a configuration capable of performing embodiments of the invention.

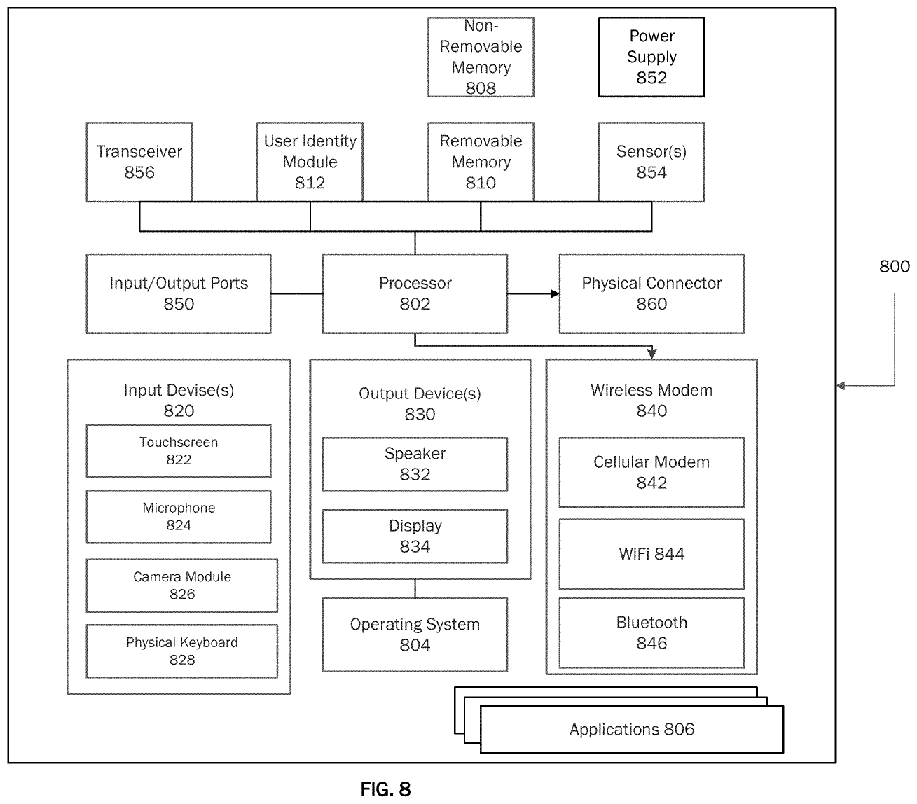

FIG. 8 is a simplified block diagram of an electronic device 800 capable of implementing the various embodiments of the present disclosure. The electronic device 800 may be an example of the system in FIG. 2. In an embodiment, the various embodiments related to managing a digital vault of the user can be facilitated using the platform installed in the electronic device 800. It should be understood that the electronic device 800 as illustrated and hereinafter described is merely illustrative of one type of device and should not be taken to limit the scope of the embodiments. As such, it should be appreciated that at least some of the components described below in connection with that the electronic device 800 may be optional and thus, in an example embodiment may include more, less, or different components than those described in connection with the example embodiment of the FIG. 8. As such, among other examples, the electronic device 800 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned other types of communication or multimedia devices.

The illustrated electronic device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 control the allocation and usage of the components of the electronic device 800 and support for one or more applications programs (e.g., the live-sign application) that implements one or more of the innovative features described herein. The applications 806 may include common mobile computing applications (e.g., telephony applications, email applications, calendars, contact managers, web browsers, messaging applications such as USSD messaging or SMS messaging or SIM Tool Kit (STK) application) or any other computing application. One or more applications for controlling the digital vault are configured to be in operative communication with other applications for example, through the OS or using API Calls, for sending/receiving notifications, such as check-in notifications.

The illustrated electronic device 800 includes one or more memory components, for example, a non-removable memory 808 and/or a removable memory 810. The non-removable memory 808 and/or the removable memory 810 may be collectively known as database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications. The electronic device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828.

Examples of the output devices 830 may include but are not limited to a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the electronic device 800 and a public switched telephone network (PSTN).

The electronic device 800 can further include one or more input/output ports 850, a power supply 852, one or more sensors 854 for example, an accelerometer, a gyroscope, a compass, or an infrared proximity sensor for detecting the orientation or motion of the electronic device 800, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 7, or one or more operations of the flow diagrams (FIGS. 1, 3, 4, 7, 10 and 11) may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device).

Such software may be executed, for example, on a single local computer or in a network environment (e.g., via the Internet, a wide-area network, a local-area network, a remoteweb-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

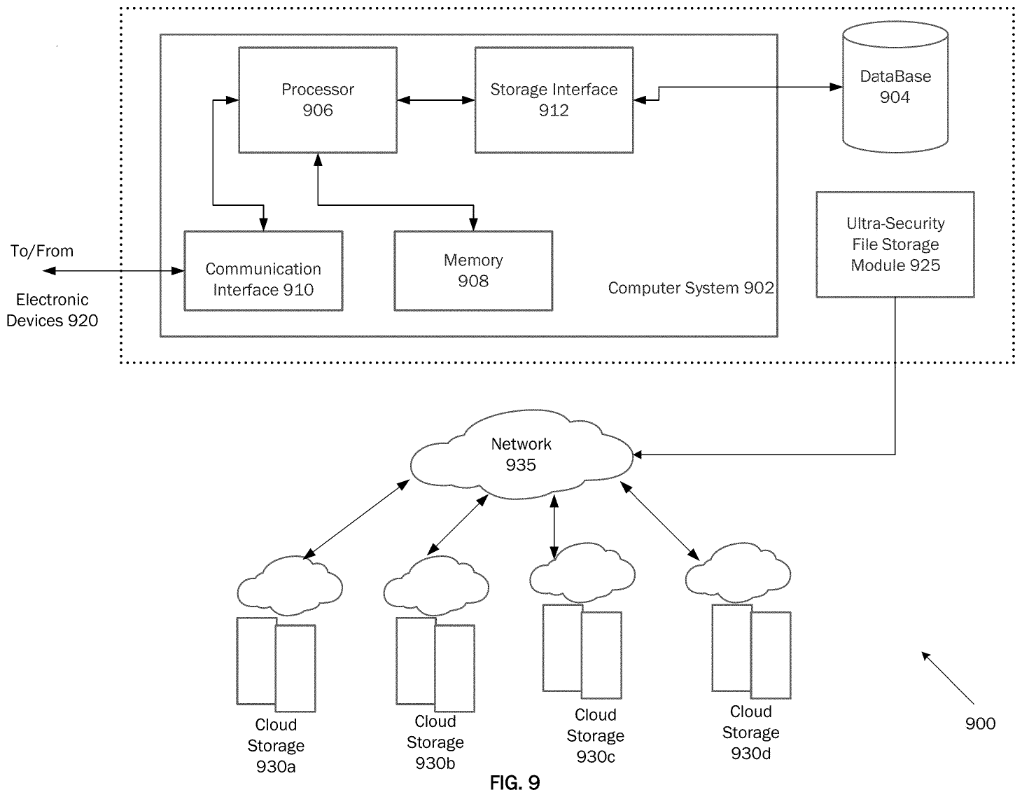

FIG. 9 is a block diagram that illustrates a server 900, which may be an example of the server 224, in accordance with an embodiment of the present disclosure. The server 900 includes a computer system 902 and one or more databases, as a database 904. The server 900 also includes an ultra-security file storage module 925. The storage module 925 can be a randomization logic that stores executable instructions to slice the encrypted or unencrypted files and store the slices on a local system 926, a shared system 928 or a network of distributed cloud storage systems such as cloud storage systems 930a, 930b, 930c and 930d connected through a network 935. Examples of the network 935 include Cellular network, Wide Area Network (WAN), wireless network, Internet, and any network employing any known communication technologies. In a non-limiting example, the sliced content (e.g., by splitting the content in many small parts) along with its metadata may be stored using block chain technology.

The computer system 902 includes a processor 906 for executing instructions. Instructions may be stored in, for example, but not limited to, a memory 908. The processor 906 may include one or more processing units (e.g., in a multi-core configuration). The processor 906 is operatively coupled to a communication interface 910 such that the computer system 902 is capable of communicating with a remote device such as an electronic device 920. Some examples of the electronic device 920 may include but are not limited to the electronic devices 226, 231, 112, 236, 241 and 246, shown in FIG. 2.

As shown in FIG. 9, The processor 906 may also be operatively coupled to the database 904. The database 904 is any computer-operated hardware suitable for storing and/or retrieving data. The database 904 may include multiple storage units such as hard disks and/or solid-state disks in a redundant array of inexpensive disks (RAID) configuration. The database 904 may include, but not limited to, a storage area network (SAN) and/or a network attached storage (NAS) system.

In some embodiments, the database 904 is integrated within the computer system 902. For example, the computer system 902 may include one or more hard disk drives as the database 904. In other embodiments, the database 904 external to the computer system 902 and may be accessed by the computer system 902 using a storage interface 912. The storage interface 912 is any component capable of providing the processor 906 with access to the database 904. The storage interface 912 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 906 with access to the database 904.

The memory 908 is a storage device embodied as one or more volatile memory devices, one or more non-volatile memory devices, and/or a combination of one or more volatile memory devices and non-volatile memory devices, for storing micro-contents information and instructions. The memory 908 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

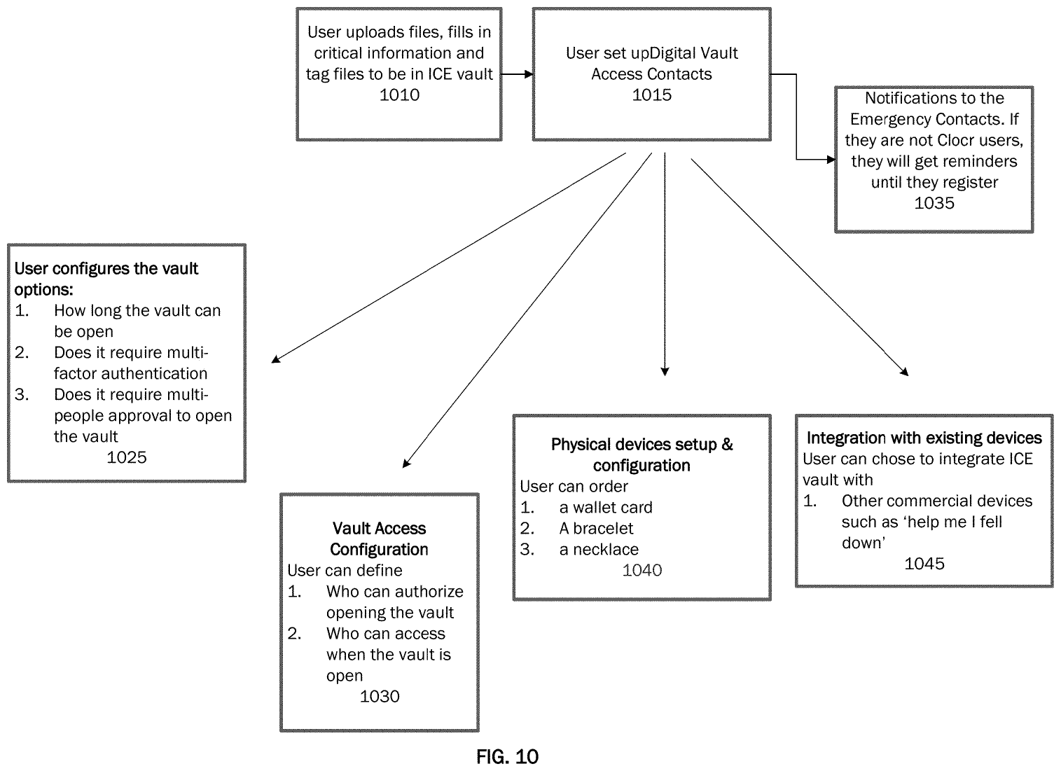

One embodiment, FIG. 10, will now be discussed in further detail as relating to the controlled, limited access to a digital vault involving a triggering event requiring access to a medical proxy of the user.

As shown in FIG. 10, the user can create a digital vault 1010. When setting up the digital vault 1010, the user may allocate digital vault access 1015. The allocation 1015 can include allocating 1030 their medical proxies to a sub-vault in their digital vault. The user may also allocate sub-vault access contacts 1030 including individual sub-vault access contacts and group sub-vault access contacts to access the sub-vault containing the medical proxies.

Upon allocation, the individual sub-vault access contacts can be notified 1035 of their status and asked to confirm that they accept the status.

The user can also allocate group digital vault access contacts including, e.g., personnel that make the health-care institutions/hospitals to ensure that proper decisions can be taken without causing any additional delays. For instance, when the user is incapacitated, group digital vault access contacts who are health-care providers are able to assess health condition information of the user and retrieve the medical proxy for making a health-care decision.

In this example, a digital sub-vault access process with reference to FIG. 2 is performed. The server 220 receives notification of a triggering event from a digital vault access contact 240 for access to the digital sub-vault containing the medical proxy. The system validates the identity of the digital vault access contacts and notifies other digital vault access contact(s) 245 about the triggering event.

Subsequent to identity verification of the digital vault access contacts 240 and/or 245, the system can provide digital vault access. The system can display, the medical proxy documents present in the sub-vault electronically or allow the medical proxy documents to be physically downloads. If necessary, the individual sub-vault access contacts can verify the details in the medical proxy documents.

### EMBODIMENTS

### Embodiment 1

Embodiment 1 describes a method and system that can be used to store and release digital information from one or more sub-vaults, based upon instructions from the user. The vaults and sub-vaults of this embodiment have controlled access and limit the release of information. This embodiment can be used for any of the myriad of vault types described in the instant application.

Embodiment 1 includes a method for providing limited, controlled access to digital information of a user by (a) creating, by a processor, a digital vault of a user, said digital vault comprising storing, by the processor, encrypted digital information of the user in one or more predetermined destination locations; (b) permitting, by the processor, the user to allocate encrypted digital information in the digital vault into one or more digital sub-vaults; (c) permitting, by the processor, the user to allocate one or more sub-vault access contacts with controlled access to one or more sub-vaults; (d) permitting, by the processor, the user to allocate digital sub-vault access to the allocated digital sub-vault access contact based on the occurrence of one or more vault access circumstances; (e) receiving, by the processor, notification that a sub-vault access circumstance has occurred; and (f) providing, by the processor, the sub-vault access contact(s), with controlled access to a sub-vault upon the occurrence of the sub-vault access circumstances, the controlled access includes (i) verifying the identity of a sub-vault access contact and (ii) allowing access for a limited period of time.

The method according to Embodiment 1, wherein creation of the digital vault can comprise uploading, by the processor, of one or more digital files to one or more predetermined destination locations and further encrypting, by the processor, each of the one or more digital files.

The method according to Embodiment 1 wherein encrypting the one or more digital files includes shredding, by the processor, of the files prior to storage. The method can further include generating, by the processor, a file hash for each of the one or more digital files that is uploaded.

The method according to Embodiment 1 can further comprise authenticating, by the processor, one or more digital files, wherein authenticating comprises (i) generating a file hash for the uploaded digital file, (ii) creating input data comprising the file hash, (iii) creating a blockchain transaction from the input data, and (iv) storing the transaction id for the blockchain transaction in a predetermined destination location. The method can further include the use of input data further comprising user information and file information.

The method according to Embodiment 1, wherein step (b) further comprises permitting, by the processor, the user to allocate encrypted digital information as information for public availability and/or dissemination, which information for public availability and/or dissemination is allocated to the occurrence of one or more vault access circumstances.

The method according to Embodiment 1, wherein step (b) further comprises permitting, by the processor, the user to allocate encrypted digital information as information for public availability and/or dissemination into one or more public information sub-vaults, which public information sub-vaults are allocated to the occurrence of one or more vault access circumstances. In one embodiment, the method can further comprise at least a portion of the information being allocated to the public information sub-vaults created in step (b) comprising exigent information of the user.

The method according to Embodiment 1, where vault access circumstances comprise a triggering event or a predetermined time.

The method can further include permitting, by the processor, the user in setting an amount of time for access to the sub-vault.

The method according to Embodiment 1, can comprise informing, by the processor, individual vault access contacts of (i) their status as sub-vault access contacts and (ii) their sub-vault access circumstances, and requesting, by the processor, confirmation of acceptance by the individual vault access contacts of their status and notifying, by the processor, the user as to whether each contact has accepted their role as sub-vault access contact.

The method according to Embodiment 1, wherein the trigger event can be reported where the system receives by the processor, a phone call related to the triggering event, and forwards the phone call to one or more of the sub-vault access contacts allocated to the triggering event.

The method according to Embodiment 1, wherein step (f) further comprises release, by the processor, of information for public availability and/or dissemination.

The method according to Embodiment 1, wherein step (e) comprises receiving, by the processor, notification from a third party present with the user. The method according to Embodiment 1 wherein the third party is an exigent response personal, such as a first responder.

The method according to Embodiment 1 wherein the system receives notification from a QR code on a card of the user and in one embodiment, that QR code is on a mobile electronic device of the user.

The method according to Embodiment 1, wherein the system receives, by the processor, notification that exigent response personnel are with the user and/or other notification, for example, notification that the user is unable to communicate effectively with the exigent response personnel.

The method according to Embodiment 1, wherein the system receives, by the processor, notification from the user of a triggering event. In one embodiment, the triggering event can be at travel emergency and the system alerts the one or more individual sub-vault contacts allocated to the triggering event.

The method according to Embodiment 1, wherein verification of the vault access contacts comprises multi-factor authorization. According to one embodiment, the sub-vault has at least two sub-vault access contacts and authentication requires inputs from at least two sub-vault contacts.

The method according to Embodiment 1, wherein the system provides access, via the processor, to information in the sub-vault in a format suitable for a mobile electronic device. According to one embodiment, the information can be downloaded from the sub-vault.

The method according to Embodiment 1, wherein the system, via the processor, notifies at least one vault administrator of the occurrence of a triggering event, which vault administrator is capable of closing the exigent account

Embodiment 1 can also include a non-transitory computer readable storage medium configured to store instructions that, when executed by at least one processor included in a computing device, cause the computing device to perform a method for providing controlled access to digital information of a user including (a) creating a digital vault comprising storing encrypted digital information of a user in one or more predetermined destination locations; (b) creating one or more digital sub-vaults comprising permitting the user to allocate the encrypted digital information in the digital vault into one or more digital sub-vaults; (c) permitting the user to allocate one or more sub-vault access contacts with controlled access to one or more digital sub-vaults; (d) permitting the user to allocate sub-vault access to one or more sub-vault access contacts based on the occurrence of one or more sub-vault access circumstances; and (e) providing the sub-vault access contact(s), with controlled access to a sub-vault consistent with the allocations of step (d), said controlled access includes (i) validating the identity of a sub-vault access contact and (ii) allowing access for a limited period of time.

The at least one non-transitory computer readable storage medium according to Embodiment 1, wherein at least one processor included in a computing device cause the computing device to perform a method where step (a) further comprises uploading one or more digital files to one or more predetermined destination locations.

The at least one non-transitory computer readable storage medium according to Embodiment 1, wherein at least one processor causes the computing device to perform a method where step (a) further comprises encrypting one or more digital files prior to storage and in one embodiment wherein encrypting the one or more digital files includes shredding of the files prior to storage.

The at least one non-transitory computer readable storage medium according to Embodiment 1, wherein at least one processor causes the computing device to perform a method wherein step (a) further comprises generating a file hash for one or more digital files that are uploaded.

The at least one non-transitory computer readable storage medium according to Embodiment 1, wherein at least one processor causes the computing device to perform a method further comprising certifying one or more digital files prior to uploading, wherein certifying comprises (i) generating a file hash for the uploaded digital file, (ii) creating input data comprising the file hash, (iii) creating a blockchain transaction from the input data, and (iv) storing the transaction id for the blockchain transaction in a predetermined destination location. The method can further include the use of input data further comprising user information and file information.

The at least one non-transitory computer readable storage medium according to Embodiment 1, wherein step (b) further comprises permitting, by the processor, the user to allocate encrypted digital information as information for public availability and/or dissemination, which information for public availability and/or dissemination is allocated to the occurrence of one or more vault access circumstances.

The at least one non-transitory computer readable storage medium according to Embodiment 1, wherein step (b) further comprises permitting, by the processor, the user to allocate encrypted digital information as information for public availability and/or dissemination into one or more public information sub-vaults, which public information sub-vaults are allocated to the occurrence of one or more vault access circumstances. In one embodiment, the at least one non-transitory computer readable storage medium according to Embodiment 1 can further comprise at least a portion of the information being allocated to the public information sub-vaults created in step (b) comprising exigent information of the user.

The at least one non-transitory computer readable storage medium according to Embodiment 1, where sub-vault access circumstances comprise a triggering event or a predetermined time.

The at least one non-transitory computer readable storage medium according to Embodiment 1, wherein at least one processor causes the computing device to perform a method wherein step (c) further comprises permitting the user in setting an amount of time for access to the sub-vault.

The at least one non-transitory computer readable storage medium according to Embodiment 1, wherein step (c) further comprises informing any allocated vault access contact of (i) their status as sub-vault access contacts and (ii) their sub-vault access circumstances.

The at least one non-transitory computer readable storage medium according to Embodiment 1, wherein at least one processor causes the computing device to perform a method wherein step (c) further comprises notifying, by the processor, the user whether each contact has accepted their role.

The at least one non-transitory computer readable storage medium according to Embodiment 1, wherein at least one processor causes the computing device to perform a method wherein step (e) further comprises receiving notification of the occurrence of a sub-vault access circumstance prior to allowing access to the sub-vault.

The at least one non-transitory computer readable storage medium according to Embodiment 1, wherein at least one processor causes the computing device to perform a method wherein step (e) further comprises alerting the one or more contacts upon the occurrence of the triggering event.

The at least one non-transitory computer readable storage medium according to Embodiment 1, wherein at least one processor causes the computing device to perform a method, wherein step (e) further comprises notifying at least one vault administrator of the existence of the triggering event, which vault administrator is capable of closing the digital vault.

The at least one non-transitory computer readable storage medium according to Embodiment 1, wherein at least one processor causes the computing device to perform a method, wherein the sub-vault access contact of step (d) comprises a group vault access contact which comprises an exigent response personnel.

The at least one non-transitory computer readable storage medium according to Embodiment 1, wherein at least one processor causes the computing device to perform a method, wherein step (e) further comprises (i) receiving a notification of the occurrence of a triggering event; and (ii) contacting the sub-vault access contacts allocated to the triggering event.

The at least one non-transitory computer readable storage medium according to Embodiment 1, wherein at least one processor causes the computing device to perform a method, wherein step (e) further comprises permitting downloading of exigent information by the sub-vault access contact.

Embodiment 1 can also include a server system for providing limited, controlled access to encrypted digital information in a digital vault, including a memory configured to store instructions; and a processor configured to execute the instructions stored in the memory and thereby cause the server system to perform the steps of (a) creating a digital vault of a user comprising storing encrypted digital information of the user at one or more predetermined destination locations; (b) permitting the user to allocate encrypted digital information so as to create one or more digital sub-vaults; (c) permitting the user to allocate one or more sub-vault access contacts with controlled access to one or more sub-vaults; (d) permitting the user to allocate sub-vault access to the sub-vault access contacts based on the occurrence of one or more sub-vault access circumstances; (e) informing any allocated sub-vault access contacts of (i) their status as sub-vault access contacts and (ii) their sub-vault access circumstances, and (f) providing, by the processor, the sub-vault access contact(s), with controlled access to a sub-vault consistent with the allocations of steps (d), said controlled access includes (i) verifying the identity of a sub-vault access contact and (ii) allowing access for a limited period of time.

The server system according to Embodiment 1, where the server system is configured to further perform step (a) comprising encrypting, uploading, and storing one or more digital files in a predetermined destination location.

The server system according to Embodiment 1, where the server system is configured to further perform encrypting of the one or more digital files in step (a) includes shredding of the files prior to storage.

The server system according to Embodiment 1, where the server system is configured to further perform step (a) further comprising generating a file hash for each of the one or more digital files that is uploaded.

The server system according to Embodiment 1, where the server system is configured to further perform step (a) further comprising certifying one or more digital files prior to uploading, wherein certifying comprises (i) generating a file hash for the uploaded digital file, (ii) creating input data comprising the file hash, (iii) creating a blockchain transaction from the input data, and (iv) storing the transaction id for the blockchain transaction in a predetermined destination location. The server system can further include the use of input data further comprising user information and file information.

The server system according to Embodiment 1, wherein step (b) further comprises permitting, by the processor, the user to allocate encrypted digital information as information for public availability and/or dissemination, which information for public availability and/or dissemination is allocated to the occurrence of one or more vault access circumstances.

The server system according to Embodiment 1, wherein step (b) further comprises permitting, by the processor, the user to allocate encrypted digital information as information for public availability and/or dissemination into one or more public information sub-vaults, which public information sub-vaults are allocated to the occurrence of one or more vault access circumstances. In one embodiment, the server system can further comprise at least a portion of the information being allocated to the public information sub-vaults created in step (b) comprising exigent information of the user.

The server system according to Embodiment 1, where the server system is configured to further perform where the sub-vault access circumstances comprise one or more triggering events.

The server system according to Embodiment 1, where the server system is configured to further perform where the sub-vault access circumstances comprise a triggering event or a predetermined time.

The server system according to Embodiment 1, where the server system is configured to further perform: step (d) further comprising permitting, by the processor, the user in setting an amount of time for access to the sub-vault.

The server system according to Embodiment 1, where the server system is configured to further perform step (d) further comprises requesting that each contact confirm acceptance of their role and notifying the user whether each contact has accepted their role.

The server system according to Embodiment 1, where the server system is configured wherein step (f) further comprises (i) receiving a notification of the occurrence of a triggering event; and (ii) contacting the sub-vault access contacts allocated to the triggering event.

The server system according to Embodiment 1, where the server system is configured wherein step (f) further comprises permitting downloading of exigent information by the sub-vault.

### Embodiment 2

Embodiment 2 describes a method and system that can be used to store and release digital information from a vault based upon instructions from the user. The vaults of this embodiment have controlled access and limit the release of information. This embodiment can be used for any of the myriad of vault types described in the instant application.

Embodiment 2 includes a method for providing limited, controlled access to digital information of a user comprising (a) creating, by a processor, a digital vault of a user, comprising storing, by the processor, encrypted digital information of the user in one or more predetermined destination locations; (b) permitting, by the processor, the user to allocate one or more digital vault access contacts; (c) permitting, by the processor, the user to allocate digital vault access to the allocated digital vault access contact of step (b) based on the occurrence of one or more vault access circumstances; (d) receiving, by the processor, notification that a vault access circumstance of step (c) has occurred; and (e) providing, by the processor, the allocated contact(s), with controlled access to digital information in the digital vault consistent with the allocations of steps (c), said controlled access includes (i) verifying the identity of a digital vault access contact and (ii) allowing access for a limited period of time.

The method according to Embodiment 2, wherein step (a) comprises uploading, by the processor, one or more digital files to the one or more predetermined destination locations.

The method according to Embodiment 2, wherein step (a) further comprises encrypting, by the processor, the one or more digital files.

The method according to Embodiment 2, wherein encrypting the one or more digital files includes shredding, by the processor, of the file prior to uploading.

The method according to Embodiment 2, wherein step (a) further comprises generating, by the processor, a file hash for each of the one or more digital files that is uploaded.

The method according to Embodiment 2, wherein step (a) further comprises certifying by the processor, one or more of the digital files, wherein certifying comprises (i) generating a file hash for the uploaded digital file, (ii) creating input data comprising the file hash, (iii) creating a blockchain transaction from the input data, and (iv) storing the transaction id for the blockchain transaction in a predetermined destination location. The method can further include the use of input data further comprising user information and file information.

The method according to Embodiment 2, wherein step (b) further comprises permitting, by the processor, the user to allocate encrypted digital information as information for public availability and/or dissemination, which information for public availability and/or dissemination is allocated to the occurrence of one or more vault access circumstances.

The method according to Embodiment 2, wherein step (b) further comprises permitting, by the processor, the user to allocate encrypted digital information as information for public availability and/or dissemination into one or more public information sub-vaults, which public information sub-vaults are allocated to the occurrence of one or more vault access circumstances. In one embodiment, the method can further comprise at least a portion of the information being allocated to the public information sub-vaults created in step (b) comprising exigent information of the user.

The method according to Embodiment 2, step (b) further comprising permitting, by the processor, the user in setting an amount of time for access of the exigent account.

The method according to Embodiment 2, step (b) further comprises notifying, by the processor, each contact allocated by the user of their role and requesting confirmation of their acceptance of their role.

The method according to Embodiment 2, step (b) further comprises notifying, by the processor, the user that each contact has accepted their role as contact or designated recipient for the user.

The method according to Embodiment 2, wherein verification of the vault access contact in step (e) comprises multi-factor authorization.

The method according to Embodiment 2, wherein step (b) comprises the allocation of at least two vault access contacts and authentication of step (e) requires, by the processor, input from at least two vault access contacts for authentication.

The method according to Embodiment 2 where vault access circumstances comprise a triggering event or a predetermined time.

The method according to Embodiment 2, step (e) further comprises alerting, by the processor, the one or more digital vault contacts allocated to the triggering event.

The method according to Embodiment 2, step (e) further comprising, notifying, by the processor, of at least one vault administrator of the existence of the triggering circumstance, which vault administrator is capable of closing the exigent account.

The method according to Embodiment 2, wherein step (d) further comprises receiving, by the processor, notification of the occurrence of a triggering event.

The method according to Embodiment 2 wherein step (d) further comprises receiving, by the processor, a phone call related to the occurrence of a triggering event, and forwarding, by the processor, the phone call to one or more of the vault access contacts allocated to the triggering event.

The method according to Embodiment 2 wherein step (d) further comprises receiving, by the processor, notification from a QR code on a card of the user.

The method according to Embodiment 2 wherein step (d) further comprises receiving, by the processor, notification from a QR code on a mobile electronic device of the user.

The method according to Embodiment 2, wherein step (d) further comprises receiving, by the processor, notification that exigent response personnel are with the user.

The method according to Embodiment 2, wherein step (d) further comprises receiving, by the processor, notification that the user is unable to communicate effectively with the exigent response personnel.

The method according to Embodiment 2, wherein step (d) further comprises receiving, by the processor, notification from the user of a triggering event.

The method according to Embodiment 2, where step (d) further comprises receiving, by the processor, notification of a travel emergency relating to the user.

The method according to Embodiment 2, where step (d) further comprises receiving, by the processor, notification of a triggering event relating to a computer system of the user.

The method according to Embodiment 2, where the triggering event is a malware attack on a computer system.

The method as claimed in Embodiment 2, where step (d) further comprises receiving, by the processor, notification of a triggering event relating to a community emergency.

Embodiment 2 may also include at least one non-transitory computer readable storage medium for providing designated recipients with limited, controlled access to digital information of a user, said medium configured to store instructions that, when executed by at least one processor included in a computing device, cause the computing device to perform a method including a) creating a digital vault, said digital vault comprising storing encrypted digital information of the user in one or more predetermined destination locations; b) permitting the user to allocate access to the digital vault to one or more digital vault access contacts; c) permitting the user to allocate digital vault access to the digital vault access contacts of step (b) based on the occurrence of one or more vault access circumstances; d) providing, by the processor, the allocated contact(s), with controlled access to the digital vault consistent with the allocations of steps (c), said controlled access includes (i) verifying the identity of a vault access contact and (ii) allowing access for a limited period of time.

The at least one non-transitory computer readable storage medium according to Embodiment 2, wherein at least one processor causes the computing device to perform a method, wherein step (a) comprises encrypting, uploading, and storing one or more digital files in a predetermined destination location.

The at least one non-transitory computer readable storage medium according to Embodiment 2, wherein at least one processor causes the computing device to perform a method, wherein encrypting the one or more digital files of step (a) includes shredding of the files prior to storage.

The at least one non-transitory computer readable storage medium according to Embodiment 2, wherein at least one processor causes the computing device to perform a method, wherein step (a) further comprises generating a file hash for each of the one or more digital files prior to uploading.

The at least one non-transitory computer readable storage medium according to Embodiment 2, wherein at least one processor cause the computing device to perform a method, wherein step (a) further comprises certifying of the digital file prior to uploading, wherein certification comprises (i) generating a file hash for the uploaded digital file, (ii) creating input data comprising the file hash, (iii) creating a blockchain transaction from the input data, and (iv) storing the transaction id for the blockchain transaction in a predetermined destination location. The method can further include the use of input data further comprising user information and file information.

The at least one non-transitory computer readable storage medium according to Embodiment 2, wherein step (b) further comprises permitting, by the processor, the user to allocate encrypted digital information as information for public availability and/or dissemination, which information for public availability and/or dissemination is allocated to the occurrence of one or more vault access circumstances.

The at least one non-transitory computer readable storage medium according to Embodiment 2, wherein step (b) further comprises permitting, by the processor, the user to allocate encrypted digital information as information for public availability and/or dissemination into one or more public information sub-vaults, which public information sub-vaults are allocated to the occurrence of one or more vault access circumstances. In one embodiment, the at least one non-transitory computer readable storage medium according to Embodiment 2 can further comprise at least a portion of the information being allocated to the public information sub-vaults created in step (b) comprising exigent information of the user.

The at least one non-transitory computer readable storage medium according to Embodiment 2, where vault access circumstances comprise a triggering event or a predetermined time.

The at least one non-transitory computer readable storage medium according to Embodiment 2, wherein at least one processor causes the computing device to perform a method, step (b) further comprising permitting the user in setting an amount of time for access to the vault.

The at least one non-transitory computer readable storage medium according to Embodiment 2, wherein at least one processor causes the computing device to perform a method, wherein step (c) further comprises notifying the vault access contacts of their role and requesting that the contacts confirm accepting the role and notifying the user whether each contact has accepted their role as contact.

The at least one non-transitory computer readable storage medium according to Embodiment 2, wherein at least one processor causes the computing device to perform a method, wherein said digital vault comprises exigent information of the user.

The at least one non-transitory computer readable storage medium according to Embodiment 2, wherein at least one processor causes the computing device to perform a method, wherein step (d) further comprises (i) receiving a notification of the occurrence of a triggering event; and (ii) contacting the vault access contacts allocated to the triggering event.

The at least one non-transitory computer readable storage medium according to Embodiment 2, wherein at least one processor causes the computing device to perform a method, wherein step (d) further comprises permitting downloading of exigent information by the vault access contact.

Embodiment 2 can further include a server system for providing limited, controlled access to encrypted digital information in a digital vault, comprising a memory configured to store instructions; and a processor configured to execute the instructions stored in the memory and thereby cause the server system to perform: a) creating a digital vault comprising storing encrypted digital information in one or more predetermined destination locations; b) permitting the user to allocate one or more digital vault access contacts; c) permitting the user to allocate digital vault access to the digital vault access contacts based on the occurrence of one or more vault access circumstances; d) providing, by the processor, the digital vault contact(s), with controlled access to digital information in the digital vault consistent with the allocations of steps (c), said controlled access includes (i) verifying the identity of the digital vault access contact and (ii) allowing access for a limited period of time.

The server system according to Embodiment 2, where the server system is configured to further perform step (a) comprising encrypting, uploading, and storing one or more digital files in a predetermined destination location.

The server system according to Embodiment 2, where the server system is configured wherein encrypting of the one or more digital files in step (a) includes shredding of the files prior to storage.

The server system according to Embodiment 2, where the server system is configured to perform step (a) further comprising generating a file hash for each of the one or more digital files that is uploaded.

The server system according to Embodiment 2, where the server system is configured to perform: step (a) further comprising certifying one or more digital file prior to uploading, wherein certification comprises (i) generating a file hash for the uploaded digital file, (ii) creating input data comprising the file hash, (iii) creating a blockchain transaction from the input data, and (iv) storing the transaction id for the blockchain transaction in a predetermined destination location. The method can further include the use of input data further comprising user information and file information.

The server system according to Embodiment 2, wherein step (b) further comprises permitting, by the processor, the user to allocate encrypted digital information as information for public availability and/or dissemination, which information for public availability and/or dissemination is allocated to the occurrence of one or more vault access circumstances.

The server system according to Embodiment 2, wherein step (b) further comprises permitting, by the processor, the user to allocate encrypted digital information as information for public availability and/or dissemination into one or more public information sub-vaults, which public information sub-vaults are allocated to the occurrence of one or more vault access circumstances. In one embodiment, the server system can further comprise at least a portion of the information being allocated to the public information sub-vaults created in step (b) comprising exigent information of the user.

The server system according to Embodiment 2 where the server system is configured wherein vault access circumstances comprise a triggering event or a predetermined time.

The server system according to Embodiment 2 where the server system is configured to perform: step (c); further comprises permitting the user in setting an amount of time for access to the vault.

The server system according to Embodiment 2 where the server system is configured to perform step (c) further comprising (i) requesting that each vault access contact confirm acceptance of their role and (ii) notifying the user whether each contact has accepted their role.

The server system according to Embodiment 2 where the server system is configured wherein said digital vault comprises exigent information of the user.

The server system according to Embodiment 2 where the server system is configured wherein the digital vault access contacts comprise group vault access contacts.

The server system according to Embodiment 2 where the server system is configured to perform step (d) further comprising (i) receiving a notification of the occurrence of a triggering event; and (ii) contacting the digital vault contacts allocated to the triggering event.

The server system according to Embodiment 2 where the server system is configured to perform step (d) further comprising permitting downloading of exigent information by the digital vault contacts.

### Embodiment 3

Embodiment 3 describes a method and system that can be used to store and release digital information upon a triggering event. The vaults and sub-vaults of this embodiment have controlled access and limit the release of information. This embodiment can be used for any of the myriad of vault or sub-vault types described in the instant application.

The digital information can include information for public availability and/or dissemination upon the occurrence of the triggering event. This aspect of the invention can find particular utility during exigent situations.

Embodiment 3 includes a method for receiving limited, controlled access to digital information of a user upon the occurrence of a triggering event comprises (a) initiating notification by an individual to a server system based on information on an identification card of a user, wherein said server system comprises a memory, and a processor capable of causing the system to create or access a digital vault comprising encrypted digital information of the user in one or more predetermined destination locations, wherein the system includes at one least vault access contact allocated for access to the vault upon the occurrence of one or more triggering events, and further wherein at least a portion of the encrypted digital information in the digital vault has been allocated for dissemination to the public upon the occurrence of one or more triggering events, and (b) receiving access to the digital information that was allocated for dissemination to the public for the triggering event, wherein said receiving step (b) further comprises providing access to at least one individual previously designated as a vault access contact by the user for the triggering event.

The method according to Embodiment 3, wherein the individual of step (a) is a third party such as an exigent response personnel.

The method according to Embodiment 3, wherein the initiating step (a) comprises reading a Quick Reference (QR) code or image on an identification card or on a mobile device of a user.

The method according to Embodiment 3, wherein step (a) comprises scanning the QR code or figure.

The method according to Embodiment 3, wherein the identification card is a physical card of the user.

The method according to Embodiment 3, wherein the identification card is a digital representation of a card on a mobile electronic device of the user.

The method according to Embodiment 3, wherein the initiating notification step (a) comprises a phone call by the individual to the computer system.

The method according to Embodiment 3, further step (b) further comprises verifying, by the individual, their identity with the computer system prior to receiving access to the information.

The method according to Embodiment 3, wherein verifying the identity in step (b) comprises taking a photograph of the individual.

The method according to Embodiment 3, wherein verifying the identity in step (b) comprises taking a photograph of an identification card of the individual.

The method according to Embodiment 3, wherein receiving step (b) further comprises communicating with the vault access contact.

The method according to Embodiment 3, wherein receiving step (b) comprises electronic communication with the vault access contact.

The method according to Embodiment 3, wherein receiving step (b) comprises a phone call with the vault access contact.

The method according to Embodiment 3 wherein receiving step (b) comprises receiving access to the information for public availability and/or dissemination of the user.

The method according to Embodiment 3, wherein the information for public availability and/or dissemination of step (b) comprises exigent information of the user.

The method according to Embodiment 3, further comprising (d) using the information from step (b) to assist the user.

### Embodiment 4

Embodiment 4 describes a method and system that can be used to store and release digital information upon a vault access circumstance, such as a triggering event. The vaults and sub-vaults of this embodiment have controlled access and limit the release of information. This embodiment can be used for any of the myriad of vault or sub-vault types described in the instant application.

Embodiment 4 includes a method for receiving limited, controlled access to digital information of a user upon the occurrence of a vault access circumstance comprises (a) receiving notification from a server system informing an individual of (i) their designation by a user as a vault access contact for the user and (ii) at least one vault access circumstance for which they are designated as a vault access contact; said server system comprises a memory, and a processor capable of causing the system to create a digital vault comprising encrypted digital information of the user in one or more predetermined destination locations; (b) receiving notification, from the server system, by the individual, that a vault access circumstance for which they have been designated has occurred; (c) verifying, by the individual, their identity with the server system, and (d) receiving information from the server system previously allocated by the user for the vault access circumstance of step (b).

The method according to Embodiment 4, where in step (a) further comprising informing the computer system, or the user, by the individual of their acceptance of the designation as a vault access contact for the user.

The method according to Embodiment 4, wherein receiving step (b) comprises receiving a phone call.

The method according to Embodiment 4, wherein receiving step (d) comprises receiving access to at least a portion of the digital vault for a predetermined period of time.

The method according to Embodiment 4, wherein receiving step (d) comprises receiving exigent information of the user.

The method according to Embodiment 4, wherein verification step (c) comprises multi-factor authorization of the individual.

Other embodiments of the present invention can include variations and modifications that will be apparent to those skilled in the art once the above disclosure is fully appreciated. It is intended that the following claims be interpreted to embrace all such variations and modifications.

We claim:

1. A method for providing limited, controlled access to digital information of a user:
a) creating, by a processor, a digital vault of a user, said digital vault comprising storing, by the processor, encrypted digital information of the user in one or more predetermined destination locations;
b) permitting, by the processor, the user to allocate encrypted digital information in the digital vault into one or more digital sub-vaults;
c) permitting, by the processor, the user to allocate one or more sub-vault access contacts with controlled access to one or more sub-vaults;
d) permitting, by the processor, the user to allocate digital sub-vault access to the one or more allocated sub-vault access contacts of step (c) based on the occurrence of one or more vault access circumstances,
e) receiving, by the processor, notification that a sub-vault access circumstance has occurred; and
f) providing, by the processor, the sub-vault access contact(s), with controlled access to a sub-vault upon the occurrence of the sub-vault access circumstances of step (d), said controlled access includes (i) verifying the identity of a sub-vault access contact and (ii) allowing access for a limited period of time.

2. The method according to claim 1, wherein step (a) comprises uploading, by the processor, of one or more digital files to one or more predetermined destination locations.

3. The method according to claim 2, wherein step (a) further comprises encrypting, by the processor, each of the one or more digital files.

4. The method according to claim 3, wherein encrypting the one or more digital files includes shredding, by the processor, of the files prior to storage.

5. The method according to claim 2, wherein step (a) further comprises generating, by the processor, a file hash for each of the one or more digital files that is uploaded.

6. The method according to claim 2, step (a) further comprises authenticating, by the processor, one or more digital files, wherein authenticating comprises (i) generating a file hash for the uploaded digital file, (ii) creating input data comprising the file hash, (iii) creating a blockchain transaction from the input data, and (iv) storing the transaction id for the blockchain transaction in a predetermined destination location.

7. The method as claimed in claim 1, wherein step (b) further comprises permitting, by the processor, the user to allocate encrypted digital information as information for public availability and/or dissemination, which information for public availability and/or dissemination is allocated to the occurrence of one or more vault access circumstances.

8. The method as claimed in claim 1, wherein step (b) further comprises permitting, by the processor, the user to allocate encrypted digital information as information for public availability and/or dissemination into one or more public information sub-vaults, which public information sub-vaults are allocated to the occurrence of one or more vault access circumstance.

9. The method as claimed in claim 8, wherein at least a portion of the information allocated to the public information sub-vaults created in step (b) comprises exigent information of the user.

10. The method as claimed in claim 1, wherein step (c) further comprises;
permitting, by the processor, the user in setting an amount of time for access to the sub-vault.

11. The method as claimed in claim 1, wherein step (c) further comprises:
informing, by the processor, the one or more sub-vault access contacts of (i) their status as sub-vault access contacts and (ii) their sub-vault access circumstances.

12. The method as claimed in claim 11 wherein step (c) further comprises
requesting, by the processor, confirmation of acceptance by the vault access contacts of their status.

13. The method according to claim 12, step (c) further comprises:
notifying, by the processor, the user as to whether each contact has accepted their role as sub-vault access contact.

14. The method as claimed in claim 1 where sub-vault access circumstances of step (d) comprise a triggering event or a predetermined time.

15. The method as claimed in claim 1, wherein step (e) comprises
receiving, by the processor, notification from a third party present with the user.

16. The method as claimed in claim 15 wherein step (e) comprises
receiving, by the processor, a phone call related to the triggering event, and
forwarding, by the processor, the phone call to one or more of the sub-vault access contacts allocated to the triggering event.

17. The method as claimed in claim 15 wherein step (e) comprises
receiving, by the processor, notification from at least one contactless communication device on a card of the user.

18. The method as claimed in claim 17, wherein the contactless communication device is a QR code, a Bluetooth device or an NFC device.

19. The method as claimed in claim 15 wherein step (e) comprises
receiving, by the processor, notification from at least one QR code on a mobile electronic device of the user.

20. The method as claimed in claim 7, wherein step (f) further comprises release, by the processor, of at least a portion of the information for public availability and/or dissemination.

21. The method as claimed in claim 1, wherein step (e) further comprises receiving, by the processor, notification that the user is unable to communicate effectively with the third party present with the user.

22. The method as claimed in claim 1, wherein step (e) further comprises receiving, by the processor, notification from the user of a triggering event.

23. The method according to claim 1, where step (e) further comprises:
receiving, by the processor, notification of a travel emergency relating to the user.

24. The method according to claim 1, step (f) further comprises (ii) alerting, by the processor, the one or more sub-vault contacts allocated to the triggering event.

25. The method as claimed in claim 1, wherein verification of step (f) comprises biometric authorization of a sub-vault access contact.

26. The method as claimed in claim 1, wherein verification of step (f) comprises facial identification authorization of a sub-vault access contact.

27. The method as claimed in claim 1, wherein verification of step (f) comprises multi-factor authorization of a sub-vault access contact.

28. The method as claimed in claim 1 wherein each sub-vault has at least two sub-vault access contacts and authentication of step (f) requires, by the processor, authorization of at least two sub-vault contacts.

29. The method according to claim 1, step (f) comprises:
providing, by the processor, access to information in the sub-vault in a format suitable for a mobile electronic device.

30. The method as claimed in claim 1, step (f) further comprising:
permitting, by the processor, the downloading of digital information from the sub-vault.

31. The method as claimed in claim 1, step (f) further comprising:
notifying, by the processor, of at least one vault administrator of the occurrence of a triggering event, which vault administrator is capable of closing the vault.
